(19) United States
(12) Patent Application Publication
(10) Pub. No.: US 2026/0045061 A1
(43) Pub. Date: Feb. 12, 2026

(54) Systems and Methods for Multitask Detection

(71) Applicant: Metropolis IP Holdings, LLC, Santa Monica, CA (US)

(72) Inventors: Yang Yuan, Belfast (GB); Xuan Guo, Belfast (GB); Dieter Joecker, Burgthann (DE)

(21) Appl. No.: 19/287,215

(22) Filed: Jul. 31, 2025

Related U.S. Application Data
(60) Provisional application No. 63/680,649, filed on Aug. 8, 2024.

(51) Int. Cl. G06V 10/25; G06T 7/73; G06V 20/70

(52) U.S. Cl. CPC G06V 10/25; G06T 7/73; G06V 20/70; G06T 2207/20081; G06V 2201/07

(57) ABSTRACT

A system or method for multitask detection of human subjects in images. The system is configured to receive a captured image comprising one or more human subjects and to detect, using a pre-trained multitask detection model, a plurality of body portions for each subject, including at least a head, a body, and multiple posture body points. For each detected body portion, the system determines a semantic center representing an anatomically consistent location. The system further computes a plurality of vectors between the semantic centers of the body portions. Using these vectors, the system associates body portions belonging to the same human subject through part-to-part matching. For each subject, the system generates a bounding box annotation that encloses the associated body portions within the image.

### CROSS REFERENCE TO RELATED APPLICATION

This application claims priority to and the benefit of U.S. Provisional Patent Application No. 63/680,649, filed on Aug. 8, 2024, which is incorporated herein by reference in its entirety.

### TECHNICAL FIELD

The present disclosure relates generally to computer vision and machine learning, and more particularly to systems and methods for performing multitask detection of subjects in digital images and video streams.

### BACKGROUND

Traditional video surveillance and behavior detection systems typically rely on separate, task-specific detectors for identifying human features such as faces, heads, and bodies. These fragmented approaches introduce inefficiencies and inconsistencies, as each component must be executed independently and lacks shared context. As a result, grouping different body parts into coherent subject representations becomes error-prone-especially in crowded scenes or where parts of the body are occluded or out of frame.

Many such systems often also use bounding-box-based localization, which depends on geometric centers that often fail to reflect a person's true anatomical position. When a subject moves dynamically, extends limbs, or appears in a non-frontal pose, the bounding box center shifts in ways that impair tracking and behavior analysis. This inconsistency limits the stability and reliability of downstream tasks like pose estimation or human activity recognition.

Furthermore, conventional pose estimation models assume full-body visibility and are highly sensitive to missing joints or partial occlusion. These systems fail to produce useful results in many common scenarios-such as detecting someone partially obscured by furniture or another person.

### SUMMARY

The disclosed systems and methods address the above described problem by applying a multitask detection model.

In some embodiments, a system is configured to receive an input image comprising one or more human subjects. In response to receiving the image, the system detects, using a multitask detection model, a plurality of body portions associated with the human subjects, including at least a head, a body, and multiple posture body points. For each detected body portion, the system determines a semantic center—an anatomically consistent point that is independent of a bounding box's geometric center. In some embodiments, the semantic center is derived as a mid-torso point computed from shoulder and hip joint locations.

To associate the detected body portions, the system computes a plurality of vectors between the semantic centers of the body portions. These vectors, which may include two-dimensional displacement predictions, are used by the system to associate sets of body portions belonging to the same individual. In some embodiments, this association is performed using a hierarchical matching process that considers both detection confidence and geometric alignment.

The system generates, for each detected human subject, a bounding box that encapsulates the associated set of body portions. In some embodiments, the system also computes visibility confidence scores for each detected posture body point to determine the likelihood of its presence in the image. These visibility scores may be used by the system to guide part association, particularly under occlusion or low-visibility conditions.

In some embodiments, for posture estimation, the system employs a two-stage regression architecture. In the first stage, intermediate body landmarks are predicted from semantic centers. In the second stage, image patches centered on these landmarks are analyzed to refine the final joint locations, improving anatomical accuracy.

In some embodiments, the multitask detection model used by the system is trained through a knowledge distillation process. A set of teacher models—each trained to detect a specific body portion (e.g., head or body)—are first trained on labeled datasets. These teacher models are then applied to unlabeled data to generate predicted annotations. The system uses these pseudo-labeled images to train a single student multitask model capable of detecting all target body portions in a unified framework.

By integrating body detection, posture estimation, and semantic association into a single system, the disclosed embodiments enable real-time, accurate analysis of human subjects for applications in surveillance, behavior monitoring, and safety alerting

### BRIEF DESCRIPTION OF THE DRAWINGS

FIG. 1 is an illustration of a system for multitask detection, in accordance with one or more embodiments.

FIG. 2 is a flow chart of a method for multitask detection, in accordance with one or more embodiments.

FIG. 3 is a block diagram illustrating the operation of an exemplary machine learning model operating according to the method of FIG. 2, in accordance with one or more embodiments.

FIG. 4 is an illustration of an exemplary output of the model of FIG. 3, in accordance with one or more embodiments.

FIG. 5A is an illustration exemplifying a center of a bounding box of the body of a human being detected in an image, in accordance with one or more embodiments.

FIG. 5B is an illustration exemplifying a semantic center of the body of the human being of FIG. 5A, in accordance with one or more embodiments.

FIG. 6A is an illustration exemplifying a visible bounding box of the visible portion of a partially occluded body of a human subject detected in an image, in accordance with one or more embodiments.

FIG. 6B is an illustration exemplifying a bounding box bounding the location of the entire body of the human subject of FIG. 6A, in accordance with one or more embodiments.

FIG. 7 is an illustration of the decoding of a bounding box of the body of a human subject according to the model of FIG. 3, in accordance with one or more embodiments.

FIG. 8A is an illustration of the output of a first stage of a two-stage approach for the determination of posture body points according to the model of FIG. 3, in accordance with one or more embodiments.

FIG. 8B is an illustration of the output of a second stage of a two-stage approach for the determination of posture body points according to the model of FIG. 3, in accordance with one or more embodiments.

FIG. 9 is an illustration of an exemplary association between a detected, face, head and body of a human subject according to the model of FIG. 3, in accordance with one or more embodiments.

FIG. 10 is a flow chart of an exemplary method for training a multitask detector such as the model of FIG. 3, in accordance with one or more embodiments.

FIG. 11 is an illustration of an exemplary training and/or applying of a machine learning model for predicting a semantic center of a body of a human subject in an annotated image, in accordance with one or more embodiments.

FIG. 12 is an illustration of an exemplary training and/or applying of a machine learning model for predicting a bounding box of a body of a human subject which is partially obstructed, in accordance with one or more embodiments.

FIG. 13 is a flowchart of a method 1300 for multitask detection for human subjects in a monitored environment, in accordance with one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Traditional human detection and tracking systems in video analytics face several technical limitations that reduce their effectiveness in real-world deployments. These systems typically use separate models for detecting body parts such as faces, heads, and full bodies, which results in fragmented outputs that are difficult to associate with a single individual. Such modular approaches lack shared context, leading to inconsistencies in part-to-part association especially in crowded scenes or where body parts are partially occluded.

Further, these systems often rely on geometric bounding box centers for localization, which are unstable in non-frontal poses or when limbs extend beyond the body region. This undermines tracking, pose estimation, and activity recognition accuracy. Moreover, traditional systems struggle to maintain persistent subject identity across sequential video frames, as they depend on simple heuristics or weak appearance features that are sensitive to lighting changes, occlusion, or camera movement.

Pose estimation also suffers under these conditions. Most conventional models assume full-body visibility and fail to produce coherent outputs when joints are missing or obscured. Existing multitask training across body parts is further complicated by data imbalance and lack of robust optimization, resulting in poor generalization. Additionally, most systems lack any mechanism to predict or account for the visibility of individual joints, reducing inference robustness.

The embodiments described herein address the above-described issues through training and applying a multitask detection model. A single multitask model is trained to predict multiple human characteristics—including face, head, body, and posture keypoints—in a unified forward pass, leveraging shared feature representations for efficiency and consistency. In some embodiments, semantic centers are used instead of geometric centers to anchor predictions, improving localization stability and anatomical alignment.

In some embodiments, the multitask model is implemented into a system including edge devices. The edge devices are configured to capture images in a monitored environment. The system applies the multitask model to process the captured images to detect, identify and/or track subjects. In some embodiments, the system is able to maintain subject identity across frames through a temporal tracking pipeline that incorporates semantic center proximity, motion vectors, appearance embeddings, and pose similarity.

In some embodiments, the system enhances pose prediction through a two-stage hierarchical inference architecture. The first stage predicts coarse intermediate anatomical landmarks, which are subsequently refined in a second stage to generate accurate joint-level keypoints. In some embodiments, the system may determine per-keypoint confidence scores, allowing for occlusion-aware interpretation of posture and reducing the likelihood of false-positive detections.

In some embodiments, during training, the system leverages a knowledge distillation framework in which multiple task-specific teacher networks supervise a unified multitask student model. This training process may be stabilized through the use of soft target outputs, task-specific loss functions, and gradient balancing techniques that ensure harmonious learning across diverse subtasks.

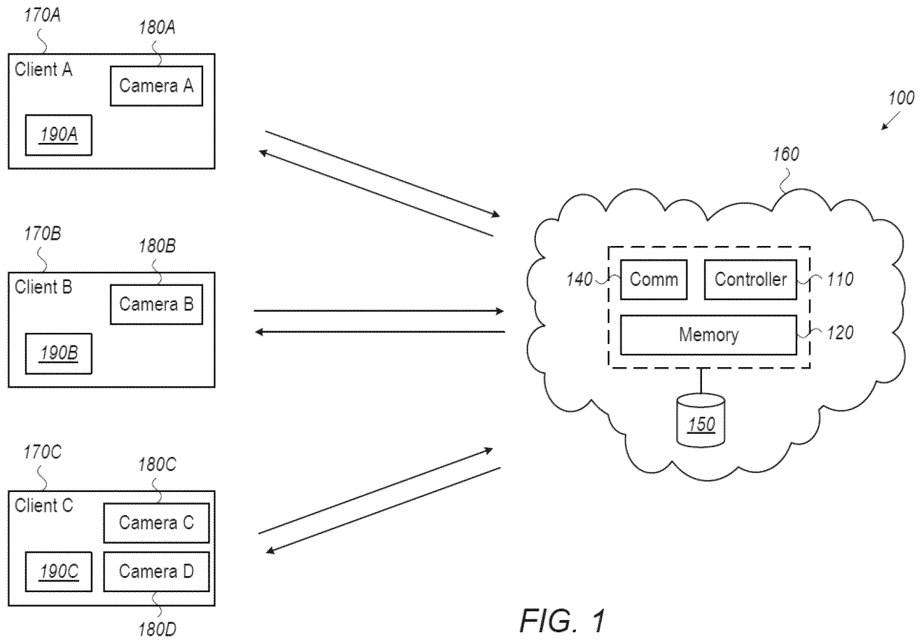

Additional details about the application and training of the multitask detection system are further described below with respect to FIGS. 1-12.

### Example Multitask Detection System

FIG. 1 is an illustration of a system 100 for multitask detection. Multitask detection, as described herein, refers to a computer-implemented technique for concurrently performing multiple human-related visual recognition tasks within a single unified model (also referred to as a multitask detection model). Rather than executing separate models for detecting different body parts or characteristics, the multitask detection system utilizes the single multitask detection model—which may be a deep learning neural network—that processes an input image to simultaneously predict various predefined human characteristics. These may include the locations of the head, face, entire body, and posture body points (e.g., skeletal joints), as well as associations between these parts and their visibility status. By generating a shared feature representation from the input image and distributing it across specialized prediction modules, the system efficiently outputs grouped and coherent information for each human subject in the scene. This integrated approach significantly reduces computational overhead, enhances detection accuracy, and supports real-time analytics for surveillance, safety, and behavior recognition applications.

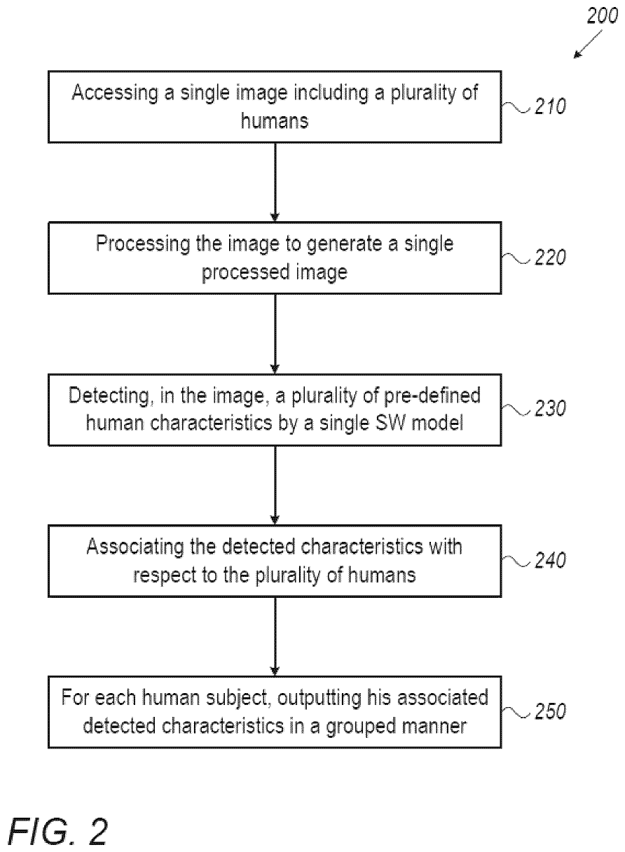

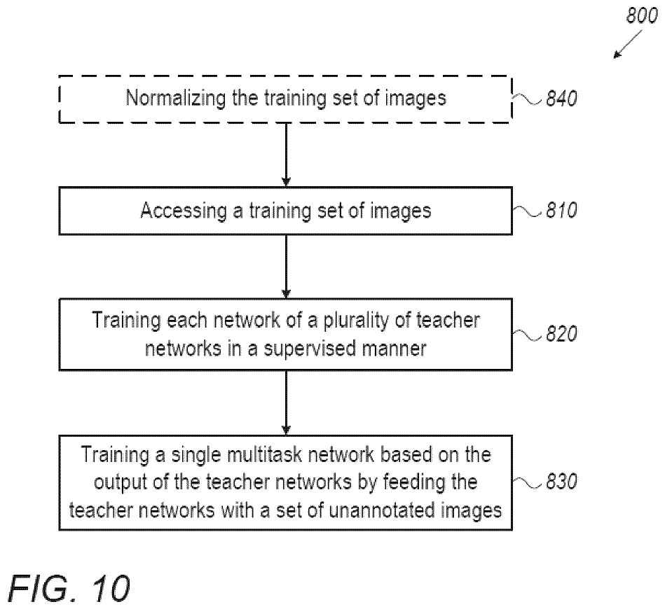

System 100 may include a hardware processor or a controller 110, a memory 120, a computer readable storage device 150 and a communication device 140. Storage device 150 may store instructions or code. An executed code (or instructions) 130 (e.g., at least a portion of the instructions or code stored in storage device 150 and are currently executed) is loaded to memory 120 from storage device 150 for execution by controller 110. The instructions may include or may apply, for example, method 200 of FIG. 2 or method 800 of FIG. 10 or may cause system 100 to generate or apply the disclosed multitask detection or the disclosed multitask detector. According to some aspects, system 100 or at least a portion of system 100 may be located on one or more cloud platforms 160.

Each of exemplary clients A, B and C may be an enterprise or an SMB (small and medium-sized enterprise) 170A, 170B and 170C, respectively, having one or more imaging devices or cameras such as exemplary respective cameras 180A, 180B, 180C and 180D. The cameras of each client may be geographically dispersed, e.g., in local branches of a retail store. Cameras A, B, C and D may be video cameras providing each a stream of images. The images may be transferred (e.g., via the internet) to system 100, e.g., via communication device 140. System 100 may process the image (e.g., via controller 110) and provide the respective customer with an output based on analysis of the received respective images.

According to some aspects, system 100 may further include edge processing devices 190A, 190B and 190C, where each edge processing device is located in the premises of client A, client B or client C, respectively. Edge processing devices 190A, 190B and 190C may be in communication with communication device 140. System 100 may include at least one edge processing device located at the premises of each client of at least a portion of the clients of system 100 (e.g., clients A, B and C). The images, or stream of images, captured by cameras 180A, 180B, 180C and 180D may be then provided to the respective edge processing device 190A, 190B or 190C. Processing of the provided images may be then performed partially or entirely by the respective edge processing device. According to some aspects, the images, the processed images or portions thereof or any other data relating to the images may be transferred to memory 120 or storage device 150, e.g., via communication device 140, for further processing, e.g., by controller 110. According to some aspects, data or metadata relating to the operation or status of the edge processing devices or their connected cameras (such as cameras 180A, 180B, 180C and 180D) may be transferred to memory 120 or storage device 150. According to some aspects, the disclosed multitask detection may be performed partially or entirely by the edge processing devices, by that allowing a more secure detection (performed at least partially on-premises), having a low latency, low network traffic and a low power consumption. The results of a partial or complete detection performed by an edge processing device may be then transferred to memory 120 or storage device 150 for completion of the multitask detection or for further processing (e.g., by controller 110), as will be exemplified herein.

According to some aspects, system 100 may be used to aggregate or combine the data, including the captured images or the processing or detection results from all the edge devices of a certain client (such as edge device 190C of client C) or of a portion or of all the clients (e.g., from edge devices 190A, 190B and 190C) to receive a global picture, e.g., per a client, per a business or per an event, as well as manage all the edge devices. For example, a building of a client may include three edge devices coupled with three or more cameras, respectively, where each camera is located at a different location within the building. For receiving the full track of a person in this building, aggregation of all the information received from all the cameras may be required.

According to some aspects, system 100 may include or provide a User Interface (UI) (not shown) such as a Graphical User Interface (GUI) which may be accessed by users representing or authorized by the clients (such as Client A, B or C). The UI may be web-based. Each client may use the UI to connect cameras to system 100, configure the provided output or image analysis provided by system 100, receive the output of system 100, e.g., in real-time, including alerts, and the like. The client may select or generate custom rules relating to the operation of system 100 with respect to the images provided by the specific client according to his specific needs. The configuration and rules of operation may be determined, for example, per client, per location, per camera location, per camera, per time, etc.

According to some aspects, the edge processing devices may be configured to allow an easy and quick deployment, allowing using existing cameras and technology infrastructure (e.g., the client's cameras and infrastructure). According to some aspects, the edge processing devices may be configured such that deployment requires plugging in the edge processing device to a power source and joining the local network (e.g., an intranet). A user (e.g., representative or authorized users of a client such as clients A, B and C) may then login to a UI of system 100. The user may, for example, via the UI, see and add existing cameras and devices, enroll subjects for person detection rules and/or watchlist alerting, configure rules and begin receiving alerts. The user may create custom rules to receive alerts on behaviors and persons of interest. The user may set alerting frequency and type (email, mobile app, messaging), behavior duration, or behavior associated with a certain person or group of persons. The user may further determine who receives alerts including remote staff, law enforcement, owners, and/or security personnel.

According to some aspects, system 100 may provide multitask detection for, e.g., safety, surveillance or security or for operational efficiency purposes. System 100 may generate or apply the disclosed multitask detection to identify people and their posture or body dynamics and based on that, identify, e.g., behaviors, actions, poses or liveness and generate alerts to the client accordingly. Once people or their body posture (e.g., including face or head) are identified and output by the disclosed multitask detector, further processing may be performed, including face recognition, as known by persons skilled in the art, e.g., to identify specific people or specific behaviors of interest. For example, system 100 may detect and provide alerts to slip and falls in real-time, predict falls based on walking analytics, prevent dementia residents of healthcare facilities wandering or elopement, track or identify threatening or dangerous people or behaviors, identify and notify of fighting on campus, count people in an area to enhance response, identify loitering, or understand traffic patterns within a space.

System 100 may provide alerts, for example, via email, SMS, and messaging applications via webhooks. The alerts may be customized, e.g., by the respective client, by person, groups of people (known and unknown), cameras, identity, activity duration and the like.

### Example Methods for Multitask Detection

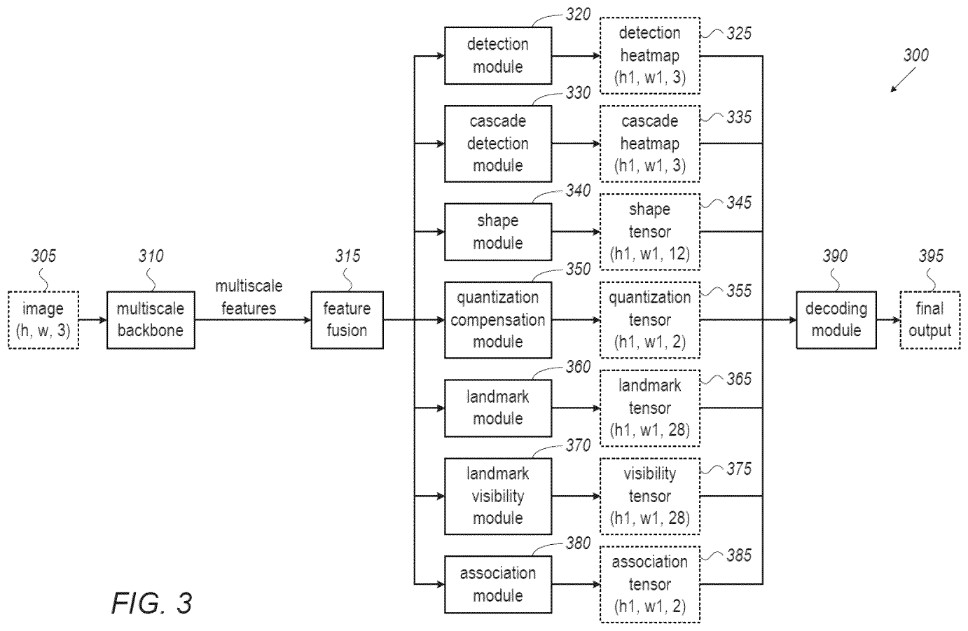

Reference is now made to FIG. 2, which is a flow chart of a method 200 for multitask detection. Reference is also made to FIG. 3, which shows a block diagram illustrating the operation of a model 300 of an exemplary single machine learning model operating according to the method of FIG. 2.

The diagram of FIG. 3 includes components or modules of model 300 indicated by a continuous line and data components (e.g., input data, processed or intermediate data and output data) indicated by a dashed line. Model 300 may be or may include a deep-learning neural network. Method 200 generally refers to detection of a plurality of predefined image-detectable characteristics of a human subject in an image. Model 300 refers to detection of human characteristics including human body portions, while the human body portions include posture body points. More specifically, and without limiting the scope of the disclosed systems and methods, the exemplary operation of model 300 will be described with respect to a configuration detecting a face, a head, a body (i.e., the entire body) and 14 posture body points of human subjects appearing in an image.

A single software-based model for multitask detection (will be also referred herein as multitask detector or detector) according to the disclosed methods, such as model 300, may include a plurality of modules. Each module may be configured to perform a different subtask. The model such as model 300, may include a detection module 320, a shape module 340 and a landmark module 360. According to some aspects, the model, such as model 300, may further include an association module 380. Model 300 is fed with a single image (e.g., an image 305), which may be then processed, while the processed image is fed to the various modules.

Detection module 320 may be configured to generate a detection heatmap for the detection of the plurality of predefined body portions, other than the plurality of predefined posture body points, based on a processed image. For example, detection module 320 may be configured to generate a heatmap detecting the face, the head and the body of human subjects in the input image.

In some embodiments, the detection module 320 is configured to detect semantic centers of a plurality of predefined body portions of a human subject in a processed image. The detection module 320 receives, as input, a shared fused feature map derived from an input image and outputs a detection heatmap 325 comprising a plurality of prediction vectors. Each element of the detection heatmap 325 includes a vector of values, wherein each value represents the confidence level that the corresponding pixel or region in the processed image corresponds to the semantic center of a particular body portion. The predefined body portions may include, but are not limited to, a face, a head, and an entire body. The detection heatmap enables identification of semantic centers associated with these body portions by evaluating the values of the vectors and applying classification or thresholding logic, such as non-maximum suppression. The semantic center is defined as an anatomically stable point—e.g., the torso center—that offers a consistent reference across different poses and partial occlusions, and is used by downstream modules, including the shape module 450 and the landmark module 360, for further localization tasks. In some embodiments, the detection module 320 operates in conjunction with a cascade detection module 330, which generates an auxiliary heatmap to reinforce or refine the predictions made by the detection module 320.

Shape module 340 may be configured to predict locations of bounding boxes for the plurality of predefined body portions in the processed image. For example, shape module 340 may be configured to predict a location of a box bounding the face, a location of a box bounding the head and a location of a box bounding the body of human subjects in the input image.

In some embodiments, the shape module 340 generates a shape tensor comprising a plurality of sets of values for each element of the processed image. Each set of values corresponds to a different predefined body portion, and each set of values predicts the spatial extent of a bounding box associated with the respective body portion, such as the face, head, or entire body. In some embodiments, each set of values includes offsets from a semantic center to the respective top, bottom, left, and right boundaries of the predicted bounding box.

In some embodiments, the prediction is performed under the assumption that the element in question corresponds to the semantic center of the respective body portion. The semantic center may be identified by a detection heatmap 325 generated by the detection module 320. The use of semantic centers, rather than geometric centroids, improves prediction robustness in cases of pose variation or occlusion.

Landmark module 360 may be configured to predict locations of the plurality of predefined posture points in the processed image. For example, landmark module 360 may be configured to predict locations of 14 predefined posture points. The landmark module 360 operates on a shared fused feature map generated by preceding modules (e.g., the backbone module and feature fusion module) and outputs a landmark tensor 365 representing keypoint positions. Each element of the landmark tensor 365 may include a plurality of sets of values, wherein each set predicts the 2D offset coordinates of a specific posture body point relative to a semantic center. The posture body points may include anatomically relevant joints such as shoulders, elbows, hips, knees, ankles, and others. In some embodiments, the landmark module predicts 14 keypoints, corresponding to a standardized human skeleton representation.

In some embodiments, the landmark module 360 assumes that the input feature map element corresponds to the semantic center of the body and outputs, for each such element, the relative position of all posture body points from that semantic center. The predicted offset vectors are then transformed into absolute image-space coordinates using the semantic center's position and any quantization corrections, if applicable.

In some embodiments, the landmark module 360 implements a two-stage regression approach. In stage one, intermediate body landmarks (e.g., midpoints between joints) are predicted directly from the semantic center. In stage two, final posture body points are refined from these intermediate predictions using local image features, enabling higher anatomical accuracy, especially in occluded or cluttered scenes. The outputs of the landmark module 360 may be used to construct a skeleton representation of each human subject, enabling further classification or analysis of human behaviors, postures, and movements.

In some embodiments, the visibility prediction is made under the assumption that the corresponding feature map element represents the semantic center of a human subject. The visibility tensor 375 may include, for example, 28 values per subject (14 joints, each corresponding to an (x, y) coordinate). A softmax function or sigmoid activation may be applied to normalize predictions to probability scores.

Association module 380 may be configured to predict associations between at least two body portions of the plurality of predefined body portions in the processed image. For example, association module 380 may be configured to associate between a face and a head of a specific subject and then associate the head and the body of the specific subject.

In some embodiments, the association module 380 is configured to receive feature maps and detection outputs, including semantic centers, bounding boxes, and posture keypoints, and determines whether multiple detected features (e.g., a head and a face) correspond to the same individual. The association module 380 generates an association tensor 385, wherein each element of the tensor contains a set of values that predict a relative spatial displacement vector between at least two predefined body portions. For example, a hook vector may predict the offset from a detected head center to the associated body semantic center, or from a face center to a head center.

In some embodiments, the association module 380 uses these predicted vectors, in conjunction with detection confidence scores and geometric plausibility constraints (e.g., body-part alignment, anthropometric ratios), to associate body parts belonging to the same subject. When multiple candidates exist, the association module 380 may resolve ambiguity using a hierarchical matching process that prioritizes confidence, spatial alignment, and historical consistency across prior frames.

The output of the association module 380 may be used to group detected body parts under unique subject identifiers, producing coherent and structured representations for each human subject in the image. This grouped output enables downstream tasks such as tracking, activity recognition, and alert generation to operate at the individual level.

According to some aspects, the single model (will be also referred herein as “model” or “the model”) such as model 300, may further include a landmark visibility module 370. Landmark visibility module 370 may be configured to predict the visibility of each posture body point of the plurality of posture body points in the processed image.

In some embodiments, the landmark visibility module 370 is configured to predict the visibility status of each of a plurality of posture body points of a human subject in a processed image. The visibility module 370 may operate in conjunction with the landmark module 360 and receives the same shared fused feature map derived from the input image 305. The landmark visibility module 370 generates a visibility tensor 375, wherein each element of the tensor 375 may include a plurality of sets of values corresponding to respective posture body points. Each set of values represents a visibility confidence score (e.g., a probability ranging from 0 to 1) indicating the likelihood that the associated body point is visible in the image.

According to some aspects, the model, such as model 300, may further include a cascade detection module 330 configured to enhance the detection performed by detection module 320. In some embodiments, the cascade detection module 330 is configured to generate a cascade detection heatmap 335, which may include a tensor of confidence values corresponding to the likelihood that each element in the processed image represents a semantic center of a predefined body portion of a human subject. The cascade detection heatmap 335 may require a higher level of detection certainty than the detection heatmap 325 generated by the detection module 320. This cascade detection module 330 may include a model trained using hard negative mining techniques and is applied in conjunction with the detection heatmap 325 to suppress false-positive detections and refine the localization of semantic centers.

According to some aspects, the model, such as model 300, may further include a quantization compensation module 350. The quantization compensation module 350 may be configured to accurate the prediction of shape module 340, e.g., by compensating for the discrete loss during a down sampling operation.

In some embodiments, the quantization compensation module 350 is configured to enhance the accuracy of bounding box predictions by compensating for spatial quantization errors introduced during downsampling operations in the feature extraction process. The quantization compensation module 350 receives as input the feature maps generated by the feature fusion module 315, along with preliminary bounding box offset predictions generated by the shape module 340. Due to the reduced spatial resolution of these processed feature maps relative to the original input image, discrete rounding effects may result in coordinate misalignment between predicted semantic centers and their true positions in the image space.

To mitigate this, the quantization compensation module 350 may output a quantization tensor, wherein each element of the tensor provides fine-grained offset values (e.g., sub-pixel corrections) for the horizontal and vertical coordinates of predicted semantic centers or bounding box anchors. These values are combined with the coarse predictions of the shape tensor to generate refined bounding box coordinates in the original image space.

According to some aspects, the model, such as model 300, may further include one or more modules for processing the input image, e.g., image 305. Model 300 may include a multiscale backbone module 310 and a feature fusion module 315 configured to generate a shared feature map to be fed to modules 320-380, also referred herein as the processed image.

In some embodiments, the multiscale backbone module 310 is configured to perform feature extraction on an input image comprising one or more human subjects. The backbone module receives the raw input image and applies a series of convolutional operations to extract multiscale feature representations capturing both low-level spatial detail and high-level semantic context. The backbone module 310 may be implemented using a deep convolutional neural network (CNN) architecture, such as a ResNet, MobileNet, or similar model, and may be pretrained on large-scale image datasets to enhance generalization. The output of the backbone module includes feature maps at multiple spatial resolutions, enabling the system to detect both coarse and fine structures within the image. These multiscale features are forwarded to the feature fusion module 315.

In some embodiments, the feature fusion module 315 is configured to generate a shared fused feature map by integrating extracted features from the input image. The feature fusion module operates in conjunction with a multiscale backbone module 310, which processes the input image to extract feature representations at multiple spatial resolutions. The feature fusion module 315 receives the multiscale feature representations and performs a fusion operation to combine them into a single processed feature map, which retains both high-level semantic information and fine-grained spatial detail. This fused feature map serves as the common input to various downstream modules, including the detection module, cascade detection module 320, cascade detection module 330, shape module 340, quantization compensation module 350, landmark module 360, landmark visibility module 370, and association module 380. In some embodiments, the fusion process may include (but is not limited to) concatenation, weighted averaging, or attention-based merging of features extracted from different convolutional layers, thereby enabling the model 300 to capture both global context and local detail in a computationally efficient manner.

According to some aspects, the model, such as model 300, may further include a decoding module 390 configured to decode the output of modules 320-380 and output a final output 395. The output of detection module 320 is a detection heatmap 325. The detection heatmap 325 may include a multi-channel spatial dataset of shape (h₁, w₁, 3), where each channel corresponds to a distinct semantic body part type, such as face, head, or body. Each spatial location in the heatmap may include a confidence score indicative of the likelihood that the corresponding location represents a semantic center of the associated body part. The detection heatmap 325 enables coarse localization of potential key body part centers across the image frame.

The output of cascade detection module 330 is a cascade heatmap 335, having same spatial dimensions as the detection heatmap 325. The cascade heatmap 335 refines and validates the coarse detections by applying more complex or contextual criteria to reduce false positives and improve localization precision.

The output of shape module 340 is a shape tensor 345, which encodes geometric bounding box information associated with predicted semantic centers. The shape tensor 345 may have a shape (h₁, w₁, 12), where 12 represents a set of bounding box parameters for one or more body parts. In some embodiments, each vector at a given spatial location may include offset values and size parameters such as for each predicted part.

The output of quantization compensation module 350 is a quantization tensor 355, which includes fine-grained spatial offset corrections to address localization errors introduced by resolution downsampling during feature extraction. The quantization tensor 355 may be of shape (h₁, w₁, 2), with each vector representing a sub-pixel offset to enhance precision in recovering the original image coordinates of predicted features.

The output of landmark module 360 is a landmark tensor 365, which encodes the relative 2D positions of a plurality of anatomical keypoints, such as skeletal joints. The landmark tensor 365 may have shape (h₁, w₁, 28), where 28 may correspond to the number of keypoints, and each keypoint is represented by an offset from the corresponding semantic center. This tensor facilitates pose estimation through reconstruction of the skeletal structure.

The output of landmark visibility module 370 is a visibility tensor 375, which represents visibility confidence scores for the anatomical keypoints predicted in the landmark tensor 365. The visibility tensor 375 may have shape (h₁, w₁, 28), with each scalar score ranging between 0 and 1, indicating the confidence that a given keypoint is visible in the current image frame. These scores may be used during inference to suppress or de-weight occluded or truncated joints in behavior analysis and pose interpretation.

The output of association module 380 is an association tensor 385, which includes a set of predicted displacement vectors used to link related body parts. The association tensor 385 may have shape (h₁, w₁, 2), with each vector representing a 2D offset from a current body part location to a target part (e.g., from head to body or face to head).

All generated tensors or heatmaps 325-385 are forwarded to a decoding module 390, which aggregates, interprets, and resolves the various predicted outputs to form a structured final output 395. This output may include grouped body parts, posture keypoints, bounding boxes, visibility flags, and subject identity representations for each detected person in the input image.

For example, the model 300 may receive, as input, an image or image frame, such as an RGB image of dimensions (h, w, 3), representing a scene containing one or more human subjects. The input image is processed through a sequence of components including a multiscale backbone module 310 and a feature fusion module 315 to generate a shared feature representation. Based on this shared representation, a plurality of task-specific modules operate in parallel to produce intermediate output tensors, including: a detection heatmap 325 from detection module 320; a cascade heatmap 335 from cascade detection module 330; a shape tensor 345 from shape module 340; a quantization tensor 355 from quantization compensation module 350; a landmark tensor 365 from landmark module 360; a visibility tensor 375 from landmark visibility module 370; and an association tensor 385 from association module 380. These tensors and/or heatmaps represent per-pixel or per-region predictions related to semantic body part detection, pose estimation, visibility assessment, and inter-part association. The decoding module 390 processes and integrates these intermediate outputs to generate a structured final output 395. The final output 395 may include, for each detected human subject, semantic center coordinates, bounding box parameters, anatomical keypoints, keypoint visibility scores, detection confidences, and association vectors, thereby providing a coherent and comprehensive representation of each subject present in the input image.

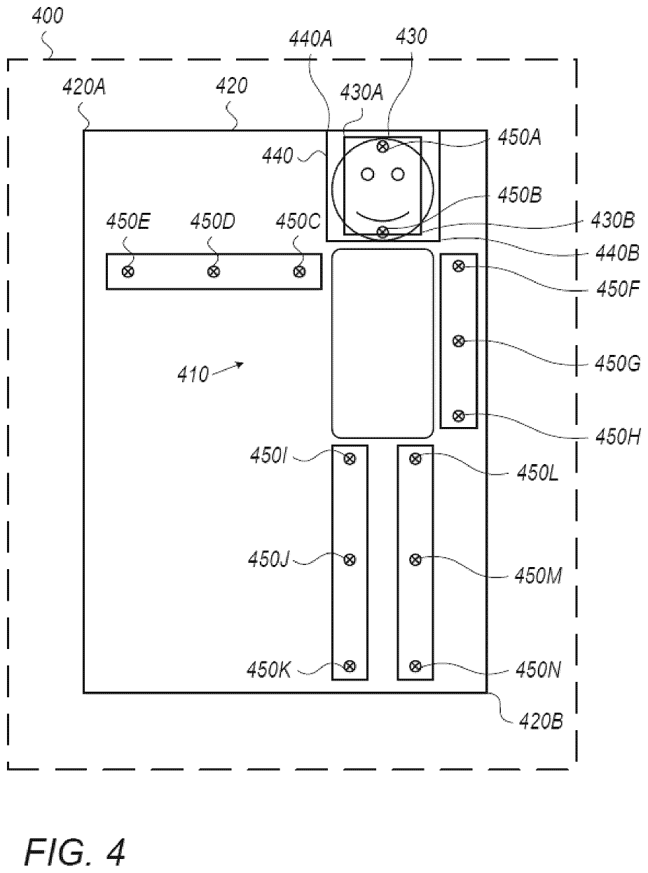

Reference is now made to FIG. 4, which is an illustration of an exemplary output of the disclosed multitask detector, such as model 300 of FIG. 3. The multitask detector may predict the face bounding boxes, head bounding boxes, body bounding boxes, 14 posture body points, and the visibility information of each posture body point in one forward pass operation, significantly reducing the running time of the pipeline.

FIG. 4 shows an image 400 including, for the purpose of illustration, a single human subject 410. However, image 400, or any other image illustrated in the drawings, may include multiple human subjects. The output of the disclosed multitask detector may include locations in the image of a body bounding box 420, a face bounding box 430, a head bounding box 440, and 14 posture body points 450A-450N.

Apart from the individual objects (e.g., face, head, body and posture body points), the detector may output the association information that allows grouping the detected bounding boxes and posture body points according to the subject identity. It should be noted that during the inference stage, the association prediction, e.g., performed by association module 380, may further reduce false detections, as will be exemplified herein.

Therefore, the final output of the detector may include rich information about the human subjects in the input image (e.g., image 400). The final output may be, for each human subject (here specifically for subject_1), for example:
subject_1=
{
‘face_box’: [x1, y1, x2, y2, score],
‘head_box’: [x1, y1, x2, y2, score],
‘body_box’: [x1, y1, x2, y2, score],
‘skeleton’: [x1, y1, vis_1, x2, y2, vis_2, . . . , x14, y14, vis_14]
},
   where ‘face_box’ refers to the face bounding box, e.g., bounding box 430, ‘head_box’ to the head bounding box, e.g., bonding box 440, and ‘body_box’ to the body bounding box, e.g., bounding box 420 of image 400. Coordinates [x1, y1] may refer to the image coordinates of the top left corner of the respective bounding box.

Accordingly, coordinates [x1, y1] may refer to the coordinates of top left corner 430A, 440A and 420A of bounding boxes 430, 440 and 420, respectively. [x2, y2] may refer to the image coordinates of the bottom right corner of the respective bounding box. Accordingly, [x2, y2] may refer to the coordinates of bottom right corner 430B, 440B and 420B of bounding boxes 430, 440 and 420, respectively. The score for each bounding box may be the confidence score for each bounding box location prediction. ‘skeleton’ refers to the posture body points. Coordinates [x1, y1] . . . [x14, y14] refer to the coordinates of the 14 posture body points in the image, such as the coordinates of posture body points 450A-450N of image 400, respectively. [vis_1 . . . vis_14] refers to the visibility score of each posture body point of the 14 posture body points in the input image (e.g., posture body points 450A-450N of image 400), respectively, as provided, by the landmark visibility module (e.g., landmark visibility module 370 of model 300 of FIG. 3).

As indicated above, model 300 is an exemplary implementation of method 200 of FIG. 2 which is a computer-implemented method for performing multitask detection. Referring now to FIG. 2, at a step 210 of method 200, a single image is accessed. The image may include a plurality of human subjects.

At a step 220, the image is processed to generate a single processed image. According to some aspects, the processing of the image may include extracting features of the image and fusing the extracted features to receive a shared fused feature map. Referring now to model 300 of FIG. 3, an image 305 having dimensions h (for height) and w (for width) is fed into multiscale backbone module 310 and feature fusion module 315 to generate the shared feature maps for all the subtasks. Feature extraction may be conducted on multiple scales and fused into the final feature map. Then, the following modules (e.g., modules 320-380) may receive the processed image (e.g., the final feature map) as input and generate their output based on it. According to some aspects, the processed image may include or may be composed of a plurality of image elements, e.g., structured image elements (will be also referred herein as “elements”).

At a step 230, a plurality of predefined image-detectable characteristics of a human subject may be detected in the processed image. According to some aspects, the detection of the plurality of predefined characteristics in the processed image is performed by a single software-based model, such as model 300 of FIG. 3. According to some aspects, the plurality of predefined characteristics of a human subject may be or may include locations of a plurality of predefined body portions of a human subject. According to some aspects, the plurality of predefined body portions are or may include a face, a head, an entire body (will be also referred herein as “a body”) and a plurality of posture body points.

In some embodiments, in response to detecting multiple subjects in close proximity, the system may use detection scores, heatmap suppression, and spatial priors to ensure that posture points and bounding boxes are not misattributed. In some embodiments, the system may group detections within a distance threshold, resolves conflicts by selecting highest-confidence detections, applies non-maximum suppression to overlapping detections, and favors associations that maintain subject coherence.

In some embodiments, the system may further perform additional steps to further resolve overlapping or conflicting predictions through overlap resolution that removes duplicate detections using intersection-over-union thresholding, consistency filtering that removes subjects with insufficient temporal persistence, smoothing that applies Kalman filtering to predicted positions and poses, and validation that verifies anatomical plausibility of final grouped outputs. Grouping may be based on semantic centers and association vectors, ensuring coherent subject representation across the temporal sequence.

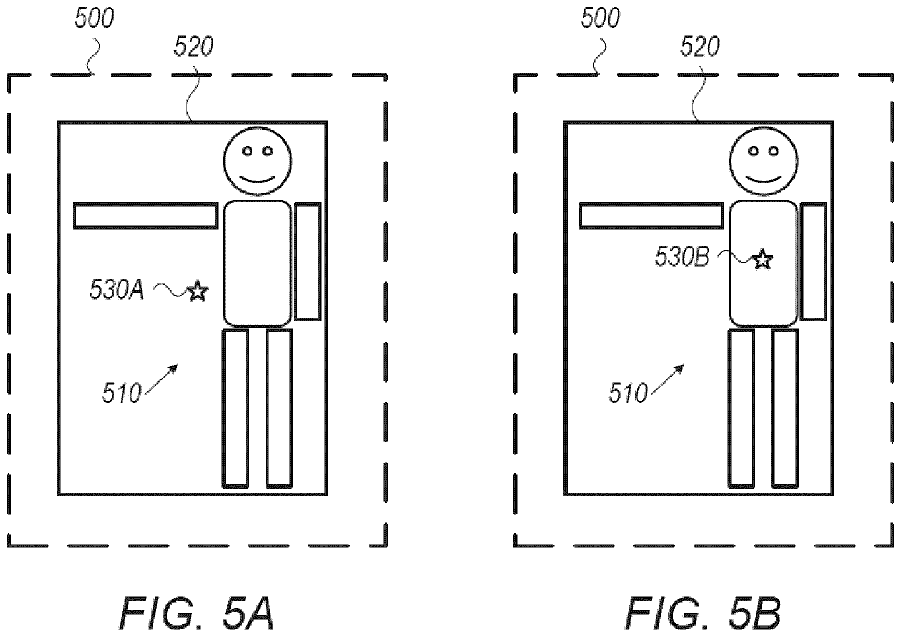

According to some aspects, the detection of locations of body portions may be performed with respect to a semantic center of the respective body. Reference is made to FIGS. 5A and 5B. FIG. 5A is an illustration exemplifying a center 530A of a bounding box 520 of the body of a human subject 510 detected in an image 500. FIG. 5B is an illustration exemplifying a semantic center 530B of the body of human subject 510 in image 500 of FIG. 5A. According to some aspects, the body bounding box predictions may be performed with respect to the semantic center of the human body. As illustrated in FIG. 5A, body bounding box 520 may extend beyond the body of subject 510, e.g., since subject 510 is stretching his right arm. Accordingly, in this case center 530A of bounding box 520 is located outside of the body of subject 510. In contrast, semantic center 530B is located at a center of the body of subject 510 and off center 530A of bounding box 520. Thus, prediction based on a semantic center (e.g., the actual body center as opposed to the body bounding box center) is much more consistent, may be highly beneficial during the model training phase and may significantly improve body portions location detection such as posture body points estimation and bounding boxes detection. According to some aspects, a semantic center predictor may be trained on fully annotated data and then the whole model training dataset may be updated with the predictor, as will be detailed hereinbelow with respect to FIG. 10.

According to some aspects, detection of the location of the entire body of human subjects in the input image (image 305 or processed image 305) is performed if at least a portion of the entire body is visible in the image. For example, a portion of the body of a subject in an image may be obstructed (e.g., by another subject or object). In such cases, the disclosed multitask detection may predict the location of the body of the subject, including the non-visible (e.g., obstructed) portion.

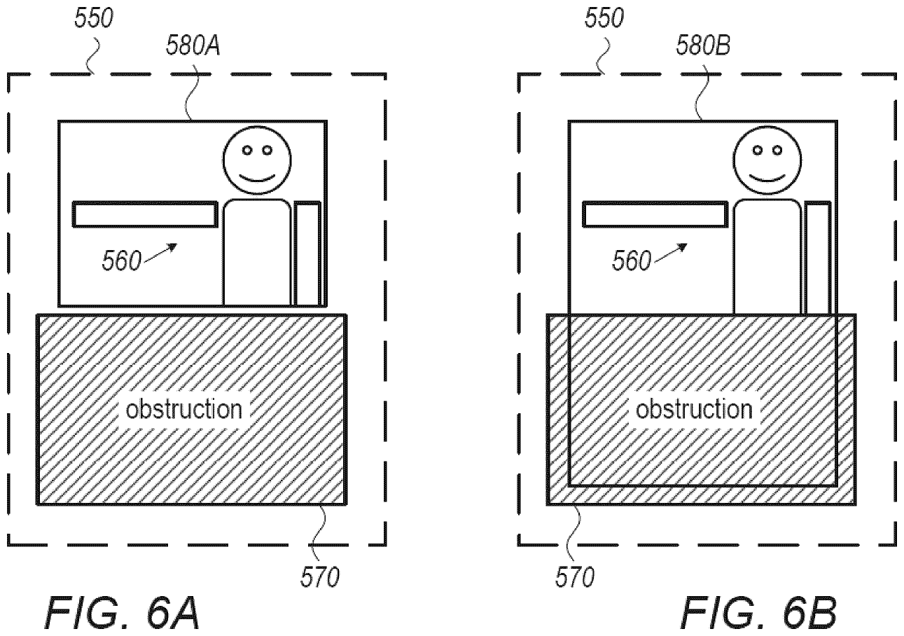

Reference is now made to FIGS. 6A and 6B. FIG. 6A is an illustration exemplifying a visible bounding box 580A of the visible portion of a partially obstructed body of a human subject 560 detected in an image 550. FIG. 6B is an illustration exemplifying a bounding box 580B bounding the location of the entire body of human subject 560 of FIG. 6A. Image 550 includes human subject 560 while a portion of the body of human subject 560 is obstructed by an obstruction 570 (e.g., a wall or furniture).

According to some aspects, bounding the entire body also in obstruction scenarios, as illustrated in FIGS. 6A and 6B, may be achieved by teaching the disclosed multitask detector to output the entire-body or body bounding box in obstruction scenarios as well. By providing a data set including annotation of the entire body also in occlusion scenarios, the knowledge of the human body's nature may be embedded into the detector. This also makes the training more consistent and stable.

According to some aspects, the detection of the plurality of predefined body portions of a human subject may include determining semantic centers for one or more of the body portions in the processed image. For each detected semantic center, the location of a bounding box bounding the respective body portion may be determined. At some cases or for some body portions, e.g., rigid body portions, like head or face, the semantic center would simply be the center of the bounding box of the body portion.

According to some aspects, the determination of semantic centers may include generating a detection heatmap, as performed, for example, by detection module 320 of model 300. The detection heatmap may include a vector of values for each different element of the processed image. Each value of the vector of values may provide a prediction for the associated element with respect to a different characteristic of the plurality of the predefined characteristics of a human subject. For example, detection heatmap 325 which is the output of module 320 may be a tensor referring to a processed and downsampled image of image 305 having spatial dimensions h1 and w1 (while typically h1<h and w1<w) and three dimension of human characteristics (specifically, body portions locations): face, head and body. Each value in this three-dimensions vector (e.g., a classification vector) may provide a probability or confidence score that the specific element is a face, a head or a body of a human subject, respectively. Decoding module 380 may then determine one or more semantic centers (e.g., depending on the number of human subjects in image 305) for each characteristic, e.g., face, head and body based on detection heatmap 325. The semantic center determination may be performed, for example, based on Non-Maximum Suppression (NMS) techniques.

According to some aspects, the determining of semantic centers may further include generating a cascade detection heatmap 335 requiring a higher level of detection certainty to eliminate or at least essentially reduce false detection (e.g., false-positive). As illustrated in FIG. 3, model 300 may include cascade detection module 330 which would output a cascade heatmap 335. The determination of semantic centers may be then performed based on the detection heatmap 325 and the cascade detection heatmap 335. According to some aspects, the heatmap tensor (e.g., detection heatmap 325) may be scanned at each location (e.g., by scanning each element of the tensor) and only save the element indexes {i, j} when detection_heatmap[i, j]>conf_threshold (confidence threshold) and cascade_heatmap[i, j]>cascade_threshold (cascade threshold). According to some aspects, the cascade detection module may be trained, as opposed to the detection module, based on hard mining techniques.

According to some aspects, the determining of a location of a bounding box for each detected semantic center may include generating a shape tensor 345 based on the processed image. The shape tensor 345 may include a tensor of values for each different element of the processed image. Each tensor of values may include a plurality of sets of values. Each set of values may predict a location of a bounding box in the processed image of a different body portion of the plurality of predefined body portions of a human subject while the respective element is assumed to be the semantic center of the bounding box. For example, shape module 340 of model 300 may output shape tensor 345 based on processed image 305. Shape tensor 345 may include a tensor for each element of the processed image, while the processed image has dimensions of (h1, w1), as discussed herein above. Each tensor may include three sets of values predicting the location of a box bounding the face, head and body of a human subject assuming the respective element is the semantic center of the face, head and body, respectively. According to some aspects, each set of values may include four values indicating the top, left, bottom and right boundary of the respective bounding box, combined with the element location {i, j}. According to some aspects, the four values may indicate the image coordinates offset with respect to the assumed semantic center coordinates. In the specific example of FIG. 3 we may then have 12 values overall for each processed image element.

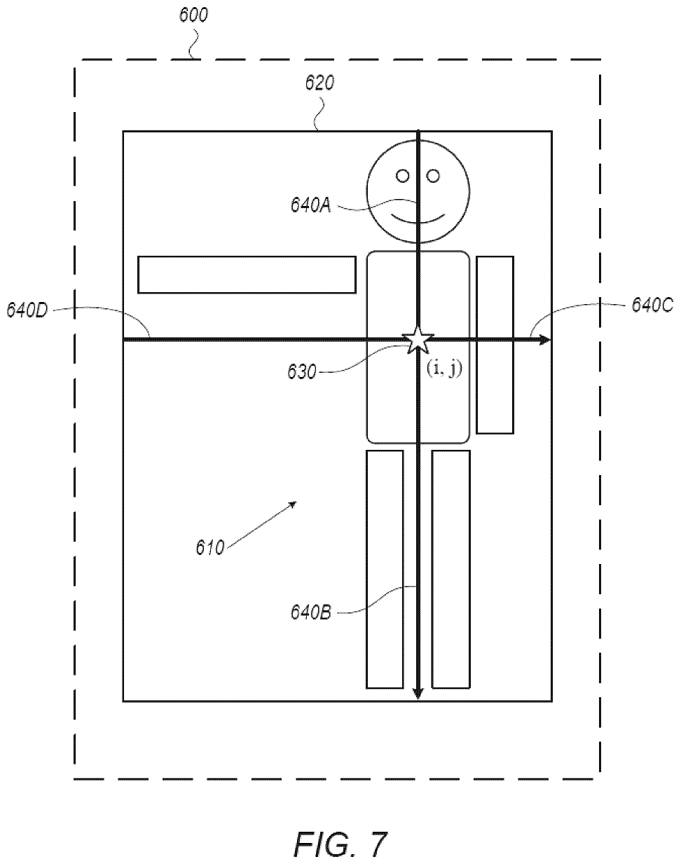

Reference is now made to FIG. 7, which is an illustration of the decoding of a bounding box 620 of the body of a human subject 610 according to the model of FIG. 3. Image 600 includes human subject 610. Point 630 is a detected semantic center of the body of subject 610 determined based the output of at least detection module 320. The location of a processed image element indicated by point 630 is associated in shape tensor 345 with a set of four values indicating a top offset 640A of a top boundary of predicted bounding box 620, a bottom offset 640B of a bottom boundary of predicted bounding box 620, a right offset 640C of a right boundary of predicted bounding box 620 and a left offset 640D of a left boundary of predicted bounding box 620, all with respect to assumed semantic center 630, not necessarily in this order. Based on these values, a location of body bounding box 620 of subject 610 may be determined within the processed image.

According to some aspects, the method may further include compensating for the discrete loss during a down sampling operation performed on the accessed image, such as image 305. Referring to model 300, the model may further include quantization compensation module 350, which may output quantization tensor 355. Tensor 355 may include two values {i_{quant}, j_{quant}} for each processed image element (referred herein also as “image element”) having coordinates {i, j}. The full bounding box information may be then determined, for example, based on the following formula for each element location {i, j}:

[i*s+i_{quant}−left,j*s+j_{quant}−top,i*s+i_{quant}+right,j*s+j_{quant}+bottom];

where s is the scale ratio between the image shape and the tensor shape: s=w/w1==h/h1.

According to some aspects, the detected semantic centers of the plurality of body portions, such as head, face and body may be matched or compared, e.g., to decrease false detection. For example, the detected semantic center of the head of a subject may be compared with the detected semantic center of the face of the subject. As another example, the detected semantic center of a head of a subject may be compared with its detected body semantic center.

According to some aspects, the one or more body portions for which a semantic center is determined include an entire body and the detected plurality of predefined body portions include a plurality of posture body points. The detection of the plurality of predefined body portions of a human subject may then further include, for each detected semantic center of a body, determining locations of the plurality of posture body points with respect to the detected semantic center.

According to some aspects, the determination of locations of the plurality of posture body points may include the generation of a landmark tensor 365 based on the processed image. The landmark tensor 365 may include a tensor of values for each different element of the processed image. Each tensor of values may include a plurality of sets of values. Each set of values of the plurality of sets of values may predict an offset of the location of a posture body point in the processed image from the location of the respective element, while the respective element is assumed to be the semantic center of the human body. According to some aspects, the plurality of posture body points is or may include a plurality of joints of a human skeleton. According to some aspects, the plurality of posture body points are 14 joints of a human skeleton. According to some aspects, the plurality of posture body points may be a number of joints of a human skeleton higher or lower than 14 joints (it may depend, for example, on the desired detection).

Referring to model 300, the model may include landmark module 360 which may output landmark tensor 365. Landmark tensor 365 may include for each element of the processed image (the image having dimensions (h1, w1)) a tensor having 14 sets of values for 14 posture body points, respectively. Each set of values may include two values indicating the location of the respective posture body point in the processed image. According to some aspects, each set of values indicates the x coordinate offset and the y coordinate offset from the location or coordinates of the respective element, while the respective element is assumed to be the semantic center of the respective human body. Thus, in this specific example, there would be 28 values overall in landmark tensor 365 for each processed image element.

According to some aspects, the generation of the landmark tensor, e.g., for determining the locations of predefined body posture points, may be performed at two stages. Accordingly the generation of the landmark tensor may include generating a first intermediate landmark tensor and a second intermediate landmark tensor. The first intermediate landmark tensor may include a first intermediate tensor of values for each different element of the processed image. Each first intermediate tensor of values may include a plurality of sets of values. Each set of values of the plurality of sets of values may predict an offset of the location of an intermediate body point in the processed image from the location of the respective element, while the respective element is assumed to be the semantic center of the human body, and the intermediate body point of the body is located in between and adjacent to two or more associated posture body points. The second intermediate landmark tensor may include a second intermediate tensor of values for each intermediate body point. Each second intermediate tensor of values may include a plurality of sets of values. Each set of values of the plurality of sets of values may predict the offset of a posture body point associated with the respective intermediate body point from the respective intermediate body point.

In some embodiments, the system may implement a hierarchical two-stage regression process to improve anatomical pose estimation accuracy. The hierarchical process may include a first stage configured to perform coarse localization and a second stage configured to perform fine refinement of predicted posture keypoints.

In the first stage, the system may predict intermediate anatomical landmarks based on semantic center locations. These intermediate landmarks may include, but are not limited to, shoulder midpoints, hip centers, and knee midpoints. The first stage may utilize a convolutional neural network (CNN) comprising three layers with a receptive field optimized for capturing global context. The output of the first stage may include a 14-dimensional vector representing estimated positions of intermediate keypoints relative to the semantic center.

In the second stage, the system may generate refined final posture keypoints using both the output of the first stage and localized image information. The second stage may include a five-layer CNN having a smaller receptive field suitable for extracting local visual features. The network may process image patches centered on the intermediate points generated by the first stage to compute a 28-dimensional vector representing final joint positions corresponding to the full pose of a human subject.

The outputs of the first and second stages may be concatenated to form a composite pose vector. In some implementations, the system may generate a 42-dimensional pose representation comprising both the 14 intermediate keypoints and the 28 refined keypoints. This hierarchical representation may facilitate multi-level anatomical reasoning and improve the consistency of skeletal predictions.

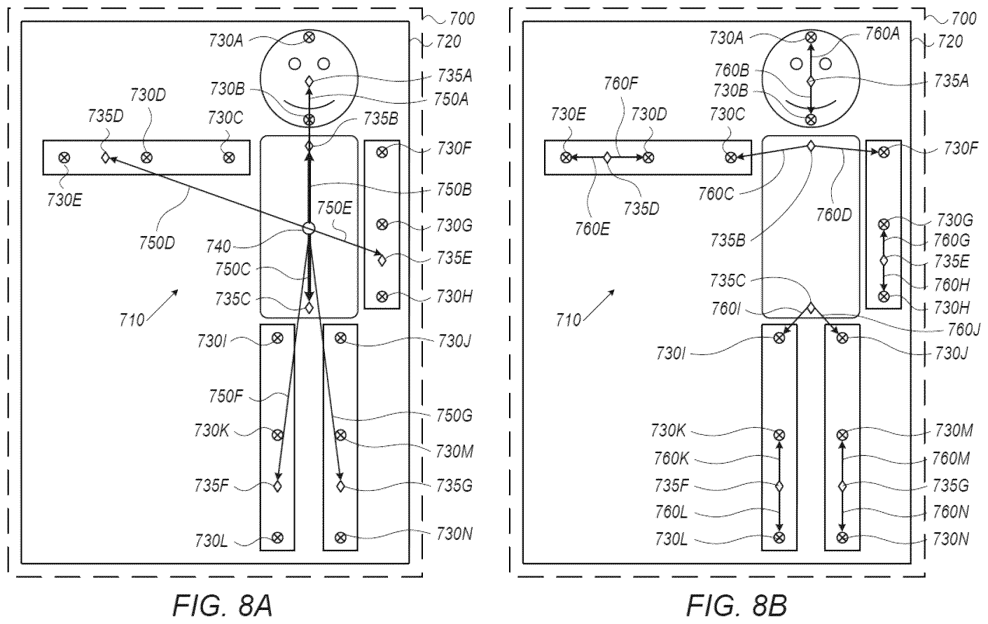

Reference is now made to FIGS. 8A and 8B. FIG. 8A is an illustration of the output of the first stage of the two-stage approach for the determination of posture body points according to the model of FIG. 3. FIG. 8B is an illustration of the output of the second stage of the two-stage approach for the determination of the posture body points according to the model of FIG. 3. FIGS. 8A and 8B show an image 700 including a human subject 710. The body of human subject 710 is bounded by a bounding box 720, determined, for example, by shape module 340 of model 300. 14 predefined posture body points 720A-730N and seven intermediate body points 735A-735G are also shown. It should be noted that the disclosed two-stage method may generate better results than one-off prediction. The two-stage approach provide refinement of the first rough prediction and provide predictions closer to the ground truth, thus allowing more effective and accurate prediction process.

According to some aspects, the two-stage approach may be performed by using two-stage regression. Landmark module 360 may include seven first stage prediction heads and seven second stage prediction heads to predict 14 posture body points. At the first stage, seven intermediate body points from the semantic center may be outputted as shown in FIG. 8A. Referring to FIG. 8A, offsets of seven intermediate body points 735A-735G from a semantic center 740 of the body of subject 710 are shown as arrows 750A-750G, respectively. At the second stage, two posture body points offset from each predicted intermediate body point from the first stage may be predicted. According to some aspects, the predictions may be generated by using the standard convolution kernel of shape. Referring to FIG. 8B, offsets of posture body points 730A-730N from intermediate body points 735A-735G are indicated by arrows 760A-760N, respectively. The second stage outputs may be then concatenate into, e.g., a 28-dimension vector of the output of landmark tensor 365 and scaled back to the image space of the input image, e.g., image 305, to receive the body posture points coordinates. Accordingly, by concatenating or combining the two types of offsets received at the two stages, offsets of predicted posture body points 730A-730N from semantic center 740 of the body of subject 710 may be received, while each posture body point may be indicated, for example, by an x-coordinate offset and a y-coordinate offset.

According to some aspects, since the predictions are provided in float numbers, a grid sample operation may be applied, for example, to extract accurate feature vectors. For example, tensors are stored with integer shapes. If a first predicted point is, for example, (3.2, 10.3), the feature vector is not simply sampled from the location (3, 10). Instead, the four closest points, e.g., (3, 10), (4, 10), (3, 11), and (4, 11), are sampled and a bilinear sampling is performed to get the final vector (e.g., by using bilinear interpolation methods).

According to some aspects, the landmark module 360 may be used to detect other human characteristics than posture body points. For example, the landmark module 360 or its output, e.g., the posture body points, may be used to detect other body portions of the human subject, such as his head, e.g., by using the detected head posture body points such as posture body points 730A and 730B of FIGS. 8A and 8B. Posture body points 730A and 730B may be then used to predict the location of the head bounding box. According to some aspects, the outputted posture body points may be used in addition or in combination to the detection module, e.g., module 320 of model 300, to decrease false detection.

According to some aspects, method 200 may further include determining the visibility of at least one detected characteristic of the detected plurality of pre-defined characteristics of a human subject in the image. According to some aspects, visibility of each of the posture body points in the image may be predicted. For example, in some images, one or more body posture points may not be visible in the image since a portion of the body of a human subject may not be visible in the image, e.g., since it is obstructed.

According to some aspects, the detection of the plurality of predefined body portions of a human subject may include generating a visibility tensor based on the processed image. The visibility tensor may include a tensor of values for each different element of the processed image. Each tensor of values may include a plurality of sets of values. Each set of values may predict visibility of the plurality of posture body points of a human subject in the processed image while the respective element is assumed to be the semantic center of the human body. Referring to model 300 of FIG. 3, landmark visibility module 370 may output visibility tensor 375, which includes for the processed image having (h1, w1) dimensions, 28 dimensions or values for each element of the image (a per of probabilities (x, 1−x) for each posture body point of the 14 posture body points). According to some aspects, the decoding of landmark visibility tensor 365 may be straightforward. The 28-dimension vector may be reshaped into 14×2 and the sigmoid function may be performed along the last dimension, to receive the visibility status for the 14 points of each subject.

At a step 240, the detected characteristics are associated with respect to the plurality of human subjects in the image. According to some aspects, the association of the detected characteristics with respect to a human subject in the image may include, for each human subject, associating at least a portion of or all the detected characteristics relating to the respective human subject. According to some aspects, when the detected characteristics include human body portions, the association of the detected characteristics with respect to a human subject may include associating detected semantic centers of at least two predefined body portions of the human subject. According to some aspects, the association of detected semantic centers of at least two predefined body portions may include associating between the detected semantic centers of the head and of the entire body of the human subject. According to some aspects, the association of the detected characteristics with respect to the plurality of human subjects in the image is also performed by the single model, such as model 300 of FIG. 3, e.g., via association module 380.

According to some aspects, the associating of detected semantic centers of at least two predefined body portions may include generating an association tensor based on the processed image, such as association tensor 385 generated by association module 380 of model 300. The association tensor may include a set of values for each different element of the processed image, e.g., having dimensions indicated by (h1, w1). Each set of values may predict a relative location between the at least two predefined body portions in the processed image, while the respective element is assumed to be the semantic center of one body portion of the at least two predefined body portions.

For example, each set of values may predict a relative location of a detected location of the head of the human subject in the processed image with respect to a semantic center of the entire body of the human subject, while the respective element is assumed to be the semantic center (or the bounding box center) of the head of the human subject. Accordingly, the vector of two values output by association module 380 of model 300, for each image element, exemplified by association tensor 385 ((h1, w1, 2)), may indicate the x-coordinate offset and the y-coordinate offset between the assumed semantic center of the head and the predicted associated semantic center of the body in the processed image space.

In some embodiments, the association module 380 is configured to resolve part-to-part and subject-level ambiguity in crowded scenes or partially occluded visual environments. The disambiguation process may utilize hierarchical matching, confidence integration, relative vector prediction, and temporal coherence to accurately group detected body parts into subject instances.

In some embodiments, the association module 380 may address multi-part detection scenarios in which multiple instances of a given body part type—such as heads, faces, or bodies—are simultaneously detected within a single frame. For example, in a crowded scene where multiple heads are detected but only a single body is visible, the association module may apply a hierarchical matching process to associate each detected head with its most probable corresponding body. This process may utilize predicted relative displacement vectors and detection confidence scores to infer the most likely associations.

In some embodiments, the association module 380 may employ a multi-tiered confidence integration approach. During a primary matching stage, detection heatmap scores are used as probabilistic confidence measures to guide initial association attempts. A secondary matching stage may apply geometric relationship priors, including expected head-to-body distance ratios and shoulder-to-hip alignment constraints, to improve association plausibility. A tertiary matching stage may incorporate temporal information by referencing historical subject groupings maintained across prior frames, thereby promoting temporal consistency in part associations.

In some embodiments, the association module 380 may further implement a hook vector framework for predicting relative displacements between body parts. In some embodiments, the association module 380 may predict a head-to-body vector comprising a two-dimensional (2D) offset from the center of a detected head to the corresponding body center. Similarly, a face-to-head vector may represent the displacement from a detected face to its associated head bounding box. Additionally, joint-to-center vectors may be predicted to link individual skeletal joints to the semantic center of the subject. These vectors enable coherent grouping of body parts into a unified anatomical structure.

In operation, the association module 380 may enable ambiguity resolution even in the presence of missing or partially occluded parts. The system may discard detections that fall below a minimum confidence threshold and validate predicted associations against anthropometric constraints to ensure geometric plausibility. The association module 380 may further prioritize associations that preserve subject-level coherence across frames and may utilize visible parts to recover the predicted positions of missing parts through spatial inference. This enables graceful degradation of the association logic under occlusion and supports reliable grouping of human features for subsequent pose estimation, tracking, and behavior analysis.

In some embodiments, the association module 380 applies a vector-based association mechanism for determining whether detected body portions in an image belong to the same human subject. This association is performed by generating and analyzing relative displacement vectors, also referred to herein as hook vectors, between semantic centers of different detected body portions.

In some embodiments, the association module 380 may predict a hook vector between a first body portion (e.g., a detected head) and a second body portion (e.g., a detected body or torso). The hook vector comprises a two-dimensional (2D) offset indicating a predicted spatial displacement from the semantic center of the first body portion to the semantic center of the second body portion in the coordinate space of the image.

The vector prediction may be performed by an association module of the multitask model, and the predicted vector may be expressed as an ordered pair (Δx, Δy), where Δx and Δy represent the horizontal and vertical displacement, respectively, between body portions. In some embodiments, the vector prediction is learned from training data and accounts for anatomical priors derived from human body proportions and pose configurations.

For example, if a head and a body are detected in the image, the association module may predict a vector from the center of the head bounding box to the semantic center of the body bounding box. The predicted vector may then be compared against an actual measured offset between those two detections. A match may be confirmed if the vector prediction and actual offset are consistent within a predefined tolerance.

In some embodiments, the system may simultaneously predict multiple hook vectors, including a head-to-body vector, indicating the expected offset from head to torso, a face-to-head vector, indicating the offset from face to head, and joint-to-center vectors, indicating offsets from individual body joints (e.g., elbow, knee) to the semantic center of the torso.

The use of such vectors enables the system to associate body parts of the same individual even when some portions of the body are partially occluded or missing from the image. The association module may also apply a hierarchical matching algorithm, wherein confidence scores from detection heatmaps, predicted vector consistency, and anthropometric constraints are jointly evaluated to determine final part-to-part associations.

Notably, the association of the detected characteristics with respect to a human subject includes grouping of detected body parts—such as face, head, and body—into a coherent representation of an individual within a single scene or frame sequence. This task can be performed significantly faster than identifying a specific person across a large-scale system, such as in traditional face recognition platforms operating against millions of identities. Here, the system only needs to distinguish among a small number of subjects visible in a given camera view, often just a handful of individuals. The association may rely on local spatial relationships (e.g., hook vectors), posture consistency, and visual proximity, without requiring permanent biometric identification. Furthermore, the task does not require matching to a global identity database or ensuring uniqueness across time or geography. As a result, the system can tolerate occasional ambiguity or overlap without compromising its core functions, making subject identification faster, less computationally intensive, and more robust to partial occlusion and varying appearance conditions.

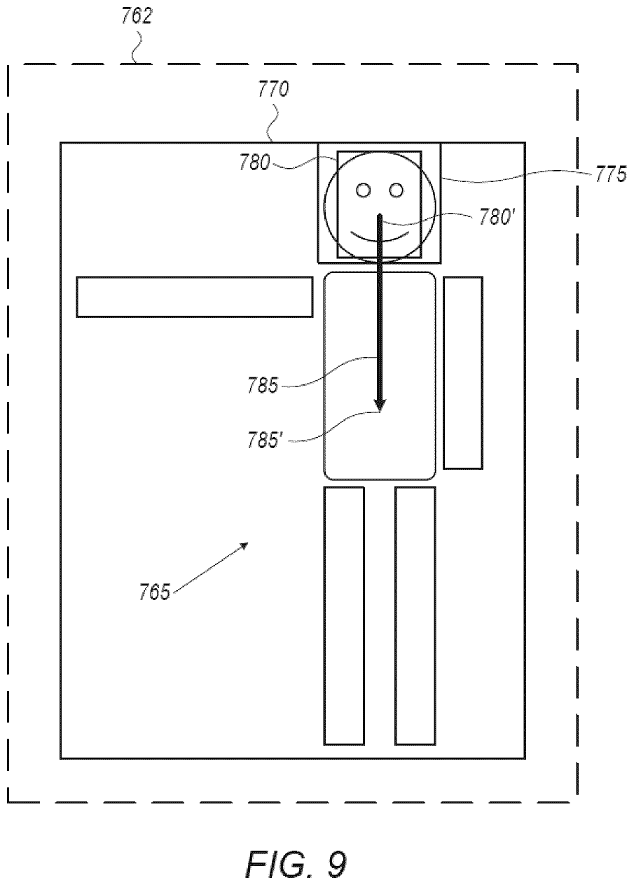

Reference is now made to FIG. 9, which is an illustration of an exemplary association between a detected face (by face bounding box 780), head (by head bounding box 775) and body (by body bounding box 770) of a human subject 765 in an image 762 according to model 300 of FIG. 3.

According to some aspects, the association between the different human body portions, e.g., the head and the body of a subject, may be performed by generating a hook vector, such as hook vector 785, which points from the center of a bounding box of a person's head (e.g., point 780′) to the semantic center of his body (e.g., point 785′).

Each head has its hook vector; ideally, it points to its corresponding body center. The distances between the hook vector ends and the actual body semantic centers may be then computed, and the distance may be then normalized with the length of the diagonal of the body box. Methods such as the Hungarian algorithm may be then applied to find the best matches and compare the distance value with a predefined threshold.

According to some aspects, the posture body points calculated, e.g., via landmark module 370 of model 300, may be utilized to remove false matches or associations. For example, the rough position and size of the head bounding box (e.g., head bounding box 775) may be estimated given the 14 posture body points (as shown for example in FIGS. 8A and 8B), while the match between this estimated head bounding box and the actual detected head bounding box (e.g., head bounding box 775) should be relatively high, for example, by applying the Intersection Over Union (IOU) technique.

According to some aspects, the plurality of predefined body portions of a human subject may further include a location of the face of a human subject. The association of the detected characteristics with the plurality of human subjects in the image may then further include associating detected locations of heads of a human subject with detected locations of faces of a human subject in the processed image.

Referring to FIG. 9. face bounding box 780 and head bounding box 775 may be associated. According to some aspects, the association may be performed based on computed IOU values between all the possible head-face pairs in the processed image and by matching these based on methods such as the Hungary algorithm. For example, face-head pairs may be determined as a match and accordingly associated if the IOU values are above a predefined threshold.

At a step 250, for each human subject of the plurality of human subjects in the image, his associated detected characteristics are outputted in a grouped manner. According to some aspects, outputting associated detected body portions may include outputting, for each human subject, the location of a bounding box in the image for each body portion associated with respect to the human subject, and such as a face bounding box, a head bounding box or a body bounding box or a combination thereof. According to some aspects, the one or more body portions for which a semantic center is determined may include an entire body and the detected plurality of predefined body portions may include a plurality of posture body points. The outputting of the associated detected body portions may then include outputting, for each human subject, the location of the plurality of posture body points associated with the respective human subject.

According to some aspects, each human subject in the image may receive an index or an identifier, e.g., subject1, subject 2 . . . etc., and for each subject his associated detected characteristics may be provided, in a grouped manner. An example for such an output may be as follows:
subject_1=
{
‘face_box’: [x1, y1, x2, y2, score],
‘head_box’: [x1, y1, x2, y2, score],
‘body_box’: [x1, y1, x2, y2, score],
‘skeleton’: [x1, y1, vis_1, x2, y2, vis_2, . . . , x14, y14, vis_14]
}.

According to some aspects, the output may be, alternatively or additionally, in a form of an illustration or be presented in a graphical manner or in a form of markings on the image. According to some aspects, the output may be fed to one or more further algorithms or SW-based models for further analysis, e.g., to identify specific human behaviors, identity of the subject (e.g., by applying face recognition techniques) and the like.

### Example Methods for Training Multitask Detection Model

According to some aspects, the multitask model or detector may be trained, e.g., via supervised or quasi-unsupervised training techniques. All tasks, such as face detection, head detection, body detection, and posture body points estimation may benefit from the disclosed multitask joint training during the training stage.

According to some aspects, the detector, such as model 300, may be trained via a training dataset which includes annotated images (e.g., trained via a supervised learning). Method 200 may then further include normalization of the training dataset. According to some aspects, the normalization of the training dataset may include generating an annotation of the semantic center of the human body in each identified body of a human subject in the annotated images.

In some embodiments, the semantic center predictor is trained using a supervised learning approach with datasets with anatomical center points annotated, typically positioned at mid-torso between hip and shoulder joints. The use of semantic centers improves prediction stability compared to geometric center-based predictions, especially in non-frontal poses or when limbs extend beyond the bounding region.

In some embodiments, the semantic center predictor includes a neural network (referred to as a semantic center prediction network) configured to receive detected bounding box coordinates and cropped image regions as input. The semantic center prediction network may include a ResNet-based feature extractor configured to process the visual information.

The semantic center predictor may learn anthropometric relationships through joint position averaging, where semantic centers are computed as weighted averages of hip and shoulder keypoints. In some embodiments, pose-dependent adjustment may be applied to modify center predictions based on detected body orientation and posture. In some embodiments, scale normalization may be applied to handle variations by normalizing centers according to subject height and width measurements.

According to some aspects, in each case the annotation of a box bounding a human body in the annotated images bounds only a portion of a human body (e.g., due to obstruction), the normalization of the training dataset may include generating a box annotation bounding the entire human body. According to some aspects, in one or more images of the training dataset only a portion of the human body may be visible in the image. Accordingly, annotation of a box bounding a human body may bound only the visible portion of the human body in such images. The rest of the human body may be obstructed, for example. In such cases, the generation of a box bounding the entire body may include a prediction of the location of the entire body including the non-visible, e.g., obstructed, portion.

In some embodiments, visibility labels are generated where keypoints in each image are marked as visible, occluded, or truncated, or heuristic rules based on occlusion maps or depth ordering. In some embodiments, automatic labeling is performed by utilizing depth ordering analysis, object overlap analysis, and image boundary intersections to determine visibility status. In some embodiments, visibility scores below a configured threshold, such as 0.3, are marked as invisible.

In some embodiments, the landmark visibility module 370 is configured to predict, for each posture body point, a confidence score indicating its visibility in the current image frame. The landmark visibility module 370 may implement a convolutional neural network (CNN) trained to output a specific-dimensional visibility tensor, with each value ranging from 0 to 1 and corresponding to a visibility confidence score for a respective keypoint. During training, the visibility scores may modulate the contribution of each keypoint to the overall pose estimation loss, such that keypoints with low predicted visibility contribute reduced weight to gradient updates. This enables the model to handle occlusion scenarios more robustly and to adapt learning dynamics based on visibility conditions. During inference, visibility scores are used to suppress unreliable posture predictions, filter out occluded joints from downstream tasks such as behavior classification, and inform other modules—such as the association module—to improve subject grouping and tracking accuracy. The integration of visibility prediction enhances overall system performance, particularly in cluttered or partially occluded scenes, by allowing the processing pipeline to dynamically adjust based on confidence in keypoint observability. For example, when a leg joint is predicted but its visibility score is lower than a predetermined threshold, downstream tasks such as behavior classification may disregard the prediction.

Traditional approaches to training a multiple detection model, wherein a single model is configured to detect multiple types of human body parts or characteristics (e.g., face, head, body, posture keypoints), encounter significant challenges in terms of training stability, accuracy, and data efficiency. A primary difficulty arises from task imbalance, where different detection tasks have access to differing quantities and qualities of labeled data. For example, datasets may contain abundant annotations for faces but sparse or inconsistent labels for posture keypoints or full-body bounding boxes. As a result, shared network parameters tend to overfit dominant tasks and underrepresent weaker ones, leading to degraded performance and biased outputs. This imbalance can adversely affect multitask learning when using a unified model trained directly on raw annotated data.

To mitigate this, the model 300 may be trained based on Knowledge Distillation (KD) technique. The model may be trained by using a plurality of teacher networks. Each teacher network may be previously trained to detect a single different characteristic of the plurality of predefined characteristics of a human subject. These teacher networks can then be applied to unlabeled images to generate rich, soft outputs such as probabilistic heatmaps and intermediate feature maps, which are then used to supervise the training of a student multitask model. The student model learns a unified representation across all subtasks using labeled data, generated by the teacher models via a knowledge distillation process. This approach allows the student model to inherit high-quality predictions from task-specialized networks while achieving balanced performance across tasks, improving training stability and generalization in data regimes where annotation coverage is uneven.

According to some aspects, each teacher network of the plurality of teacher networks may be trained in a supervised manner. For example, the teacher networks may be trained based on a set of annotated data normalized as disclosed herein. According to some aspects, the model may be trained based on the output of each trained teacher network of the plurality of teacher networks received by feeding each teacher network with unannotated data.

In some embodiments, the teacher networks used for knowledge distillation are trained using traditional supervised learning with fully labeled datasets, where each teacher specializes in predicting one human characteristic. For example, a face teacher uses a first CNN trained on face detection datasets to detect faces; a head teacher uses a second CNN trained on head detection datasets to detect heads; a body teacher uses a third CNN trained on body detection datasets to detect bodies, and so on. Teacher networks may be trained to generate probabilistic outputs including heatmaps and confidence scores rather than hard classifications, providing soft targets for student network learning. Intermediate feature representations from teacher networks guide student network learning through feature map transfer. The student multitask model may then learn from soft outputs generated by these teacher models over unlabeled or weakly labeled data.

Reference is now made to FIG. 10, which is a flow chart of an exemplary method 800 for training a multitask detector, such as model 300 of FIG. 3. At a step 810, a training set of images is accessed. Each image of the training set of images may include one or more annotations indicating one or more or ideally all characteristics of a human subject of a plurality of predefined image-detectable characteristics of a human subject. For example, the characteristics may include locations of human body portions in the image, such as face, head, entire body and posture body points as illustrated, for example, in FIG. 4. According to some aspects, the construction of the data pool may include annotating each image with at least one annotation type. For example, image A may be annotated with face bounding boxes only, image B may have both face and head bounding boxes, while image C may have face, head and body bounding boxes and the posture body points annotations.

At a step 820, each network of a plurality of teacher networks is trained based on the annotated training set of images in a supervised manner. Each teacher network may be aimed at detecting a single different characteristic of the plurality of predefined characteristics of a human subject. Referring to model 300 of FIG. 3, the related data may be pulled from the data pool and four different teacher networks specified in each task of: face detection, head detection, body detection, and posture body points estimation may be trained, respectively.

At a step 830, a single multitask network, e.g., model 300 of FIG. 3, may be trained based on an output of each network of the plurality of teacher networks by using a knowledge distillation technique. According to some aspects, the output of each teacher network may be received by feeding each teacher network with a set of unannotated images.

According to some aspects, the multitask model or detector may be generated by training a deep-learning neural network, which is smaller than the teacher networks, via a knowledge distillation algorithm, with the supervision signals from the four teacher networks.

At this stage, annotations are no longer required for the training. Thus, images may be extensively collected to ensure diversity and generalization power. As a result, the model network may also receive balanced training signals for all tasks, which may be highly significant for a multitask network. The knowledge distillation may be applied to all the subtasks or modules of the model, such as modules 320-380 of model 300.

It should be noted that multitask training may also be performed by annotating all the data with all the needed annotations or weighting all the tasks in the training code (e.g., setting the coefficient to zero if the annotation does not exist for this task). However, when the annotations are imbalanced, it takes a subtle training strategy to stabilize the training at the beginning, often resulting in a suboptimal model. According to the disclosed training, several large or heavy networks are first trained for each task, then a small or light network is trained by using knowledge distillation. A large network often has better generalization ability, so it would also generate reasonable predictions on other unannotated images. Then, the knowledge distillation ensures the small network receives the balanced signals for all the tasks, therefore, bettering its performance.

According to some aspects, the knowledge distillation may use the heatmap instead of the discrete predictions, which may soften the predictions and bring more information to the small network. The knowledge distillation may be applied to all the subtasks. For example, the smoothed Mean Squared Error (MSE) function as the loss function for heatmap-related subtasks like detection heatmap (e.g., module 320 of model 300 of FIG. 3) and cascade heatmap (e.g., module 330 of model 300). Smoothed L1 loss functions may be used for other subtasks like shape prediction (e.g., module 340 of model 300), quantization prediction (e.g., module 350 of model 300) and landmark prediction (e.g., module 360 of model 300).

According to some aspects, method 800 may further include a step 840, at which the training set of images is normalized prior to the actual training of the model (e.g., steps 810-830). According to some aspects, the normalizing of the training set of images may include generating an annotation of a semantic center of a human subject body in each identified body in the images of the training set. According to some aspects, the generation of the annotation of the semantic center may include training a semantic center predictor network and preparing training data for training the semantic center predictor network.

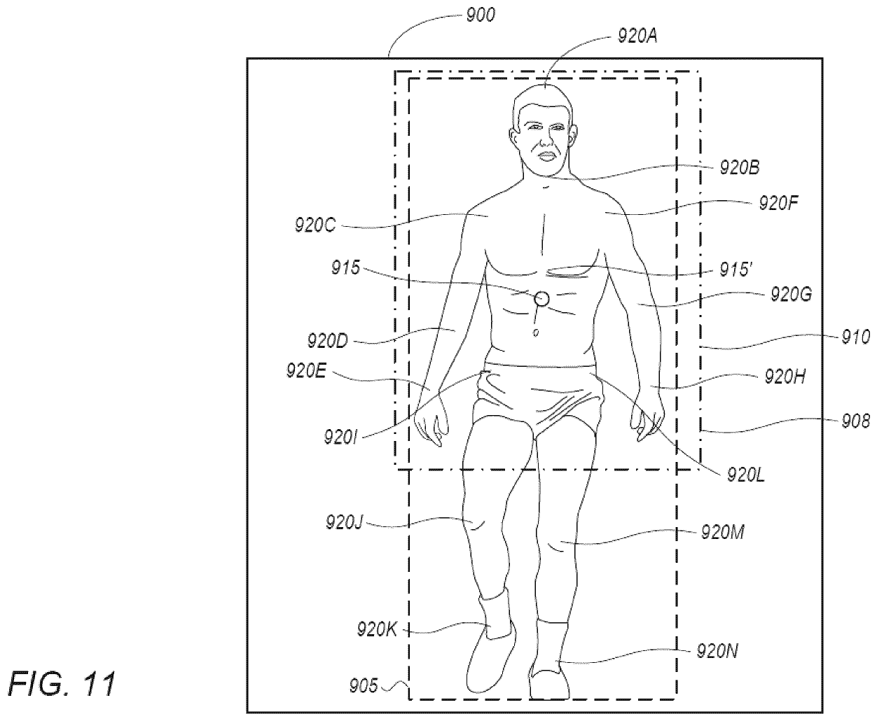

Reference is now made to FIG. 11, which is an illustration of an exemplary training of a machine learning network for predicting a semantic center 915 of a body of a human subject 910 in an annotated image 900. Image 900 is annotated with a body bounding box 905 and with 14 posture body points 920A-920N.

According to some aspects, at a first pre-training step, training data may be prepared. According to some aspects, the preparation of the training data may include calculation of a semantic center of a human subject in each image of at least a plurality of images of the training set of images. For example, for each image in the training set having posture body points annotated, the semantic center may be computed. According to some aspects, the calculation of a semantic center for an image may include calculation of a mean of a plurality of annotated posture body points in the image. For example, the mean of adjacent posture body points (e.g., adjacent to where a semantic center should be located) like the shoulder posture body points 920C and 920F and hip posture body points 9201 and 920L may be calculated.

The preparation of the training data may further include randomly cropping each image of the at least plurality of images of the training set to generate a plurality of crops for each such image. According to some aspects, the randomly cropping of each such image may include generating a crop only if the IOU between the crop and an annotated bounding box of a body of the human subject in the image is above a preset threshold. For example, image 900 may be randomly cropped such that the IOU between the cropped box, e.g., box 908, and the annotated bounding body box 905 is above a preset threshold.

For each crop, an offset between a center of the crop and the calculated semantic center for the respective image may be calculated. For example, the offset between a center 915′ of cropped box 908 and calculated semantic center 915, which is the training target, may be computed. This step may be repeated with different crops for each human subject and may end up with multiple (crop, offset) pairs, which may be used as the training set for the semantic center predictor network.

At a second step, the network is trained, e.g., by minimizing the difference between the network prediction and the target. According to some aspects, Resnet34 network, or other known network architectures, may be used as the backbone of the semantic center predictor network. The output dimension of the network may be determined to a two-number vector (e.g., indicating the offset of the body semantic center from the center of the body bounding box). The network may be then trained with the pairs of crop and offset prepared in the previous step.

According to some aspects, the normalization of the training set may include generating a box annotation bounding the entire human body, since at some cases, annotations of body bounding boxes may bound only a portion of the human body.

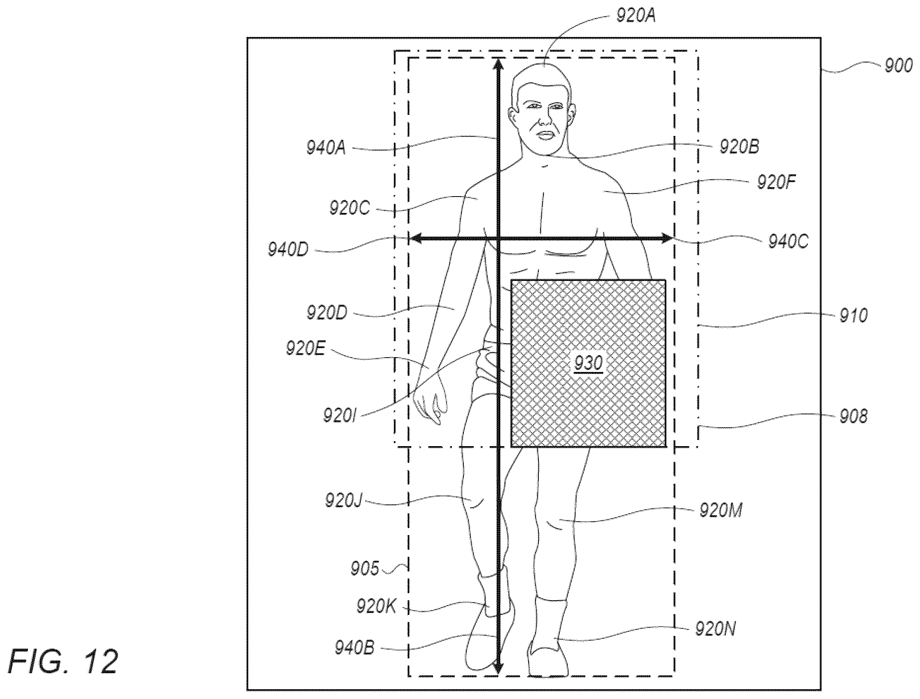

Reference is now made to FIG. 12, which is an illustration of an exemplary training of a machine learning network for predicting a bounding box 905 of an entire body of a human subject 910 which is partially obstructed by an obstruction 930. In one or more images of the training set of images, an annotation of a box bounding a human body may bound only the visible portion of the human body in the respective image. This may happen, for example, when the body of a subject is partially obstructed, as shown, for example in FIG. 12.

According to some aspects, the training of a bounding box predictor network may be similar to the training of the semantic center predictor network as described with respect to FIG. 11 with some differences as detailed hereinbelow.

The bounding box predictor network may output a four-number vector including the offset or distances to the top, left, right and bottom of the predicted bounding box from the center of the annotated body bounding box, as shown, for example, in FIG. 12. This is also the target during the data preparation step. Furthermore, during the training process, parts of the images of the training set may be randomly blackout.

According to the disclosed methods, two subtask networks may be trained to standardize the annotation styles of the training set for the disclosed multitask detector. All the image annotations in the data pool of the training set may be updated with the semantic center and the real width and height of the body bounding box rather than those of the body's visible parts.

According to some aspects, the images used for training the disclosed multitask detector (e.g., the unannotated images) may be or may include domain-specific images. The disclosed multitask detection network may be finetuned with domain-specific data, and during the training process, one may also focus on a specific scale range, such as resizing the training images to more resemble the images that would be fed, in real-time, to the detector (e.g., image captured by a Closed-Circuit Television (CCTV)).

According to some aspects, training of the disclosed multitask network may further include training the multitask network based on a set of images which do not include human subjects. The false-positive images (e.g., images falsely identified by the network in the training process as including at least one human subject) may be then added to the set of unannotated images used for training the multitask network. According to some aspects, the disclosed detector may be ran on an extensive dataset including no human subjects. The false positive images may be then collected an added back to the training set, e.g., a set of domain-specific images, and then the detector may be finetuned again with an additional cascade classification branch.

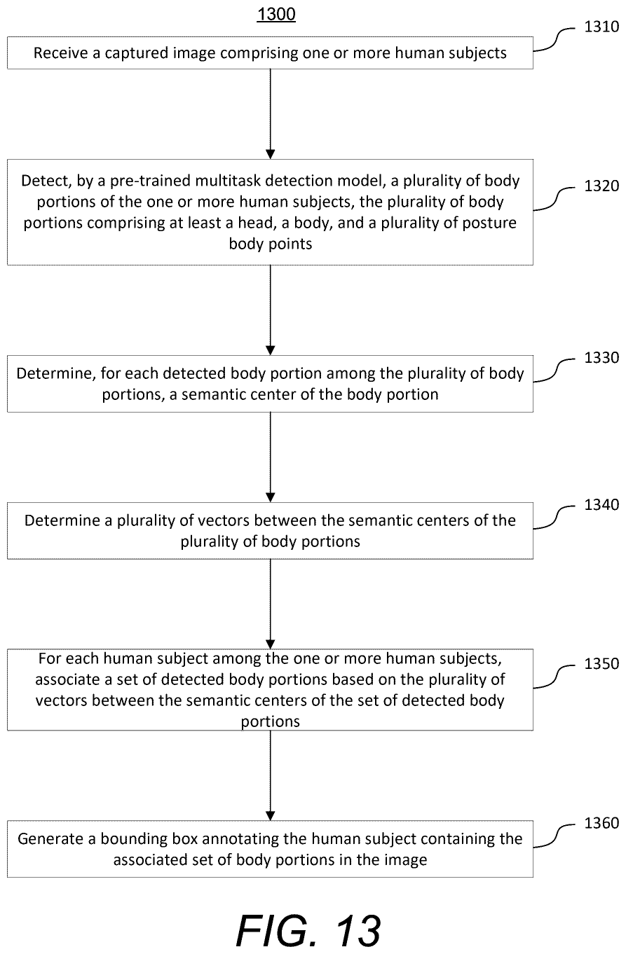

FIG. 13 is a flowchart of a method 1300 for multitask detection for human subjects in a monitored environment, in accordance with one or more embodiments. In various embodiments, the method includes different or additional steps than those described in conjunction with FIG. 13. Further, in some embodiments, the steps of the method may be performed in different orders than the order described in conjunction with FIG. 13. The method described in conjunction with FIG. 13 may be carried out by a system (e.g., online platform 160) in various embodiments, while in other embodiments, the steps of the method are performed by edge processing device(s) 190, or a combination thereof.

The system receives 1310 a captured image comprising one or more human subjects. In operation, the system initially receives a captured image, such as a still image or a video frame, that includes one or more human subjects. The captured image may originate from a variety of sources, such as surveillance cameras, mobile device cameras, or body-worn imaging devices. The image may be received as part of a live video feed, uploaded content, or a batch-processed dataset, and may include varying lighting conditions, backgrounds, or partial occlusions. The system may preprocess the image to normalize input dimensions and apply standard transformations-such as resizing, normalization, or color correction-before feeding it into a multitask detection pipeline. In some embodiments, the image may be received by an edge device located on-site (e.g., at a client facility), reducing network latency and increasing data privacy. Alternatively, the image may be uploaded to a central cloud service for processing. Regardless of the source, this initial reception marks the entry point into the system's multitask detection workflow.

The system detects 1320, by a pre-trained multitask detection model, a plurality of body portions of the one or more human subjects. The plurality of body portions comprising at least a head, a body, and a plurality of posture body points. In response to receiving the image, the system applies a pre-trained multitask detection model configured to identify a comprehensive set of human body features in a single forward pass. In some embodiments, the model is trained using knowledge distillation from multiple teacher networks-leveraging shared feature representations to detect multiple body portions concurrently, improving efficiency and consistency. In some embodiments, the system identifies discrete regions corresponding to a subject's head, full body (including potentially occluded portions), and a set of anatomically defined posture body points such as shoulders, elbows, hips, and knees. In some embodiments, the predictions are spatially localized in the image using heatmaps and offset tensors generated by the model's submodules. In some embodiments, in crowded scenes or under partial visibility, the system still attempts to detect body portions based on inferred structure or partial evidence. By combining these detection tasks into a single model, the system reduces computational overhead and ensures that detections are contextualized relative to each other, rather than treated as isolated predictions.

The system determines 1330, for each detected body portion among the plurality of body portions, a semantic center of the body portion. For each of the body portions detected in the previous step, the system computes a semantic center-a location that represents the anatomically meaningful midpoint of the body portion rather than the geometric center of a surrounding bounding box. For example, the semantic center of the body may be estimated at the midpoint between shoulder and hip keypoints, corresponding to a central torso location that is more stable under pose changes. The semantic centers may be derived by analyzing posture keypoints, applying regression outputs, or decoding predicted heatmaps generated by the model. These semantic centers provide a normalized spatial reference across different poses, scales, or partial occlusions, allowing the system to make consistent comparisons between body parts within a single subject or across different frames. In practice, this helps overcome issues where bounding boxes shift due to limb extension or side-facing orientations, which would otherwise result in spatial drift during tracking or association tasks.

The system determines 1340 a plurality of vectors between the semantic centers of the plurality of body portions. Based on the computed semantic centers, the system is able to determine a set of directional vectors connecting different pairs of body portions, such as from face to head, head to body, or from posture keypoints to the torso. These vectors encode relative spatial relationships among parts of the same human subject and serve as a compact representation of the subject's structure. For example, a vector from the head center to the body center may indicate not just position but also implied orientation. These vectors are particularly useful in distinguishing overlapping or closely spaced individuals within a scene, since they allow the system to reason about which parts belong together based on expected anatomical geometry. The vectors may also be used in downstream tasks such as hierarchical matching, subject identification, and motion continuity tracking. They can be stored as part of an association tensor or used in real-time to guide subject grouping.

For each human subject among the one or more human subjects, the system associates 1350 a set of detected body portions based on the plurality of vectors between the semantic centers of the set of detected body portions. Using the previously determined vectors, the system performs a grouping operation to associate detected body portions-such as head, face, body, and joints-into coherent sets corresponding to individual human subjects. This association step leverages both spatial proximity and consistency of vector direction and magnitude to disambiguate between overlapping or occluded persons. For instance, in a crowded environment where multiple heads and bodies are visible, the system uses head-to-body and face-to-head vectors to assign body portions to the correct subject, resolving ambiguity using geometric alignment and detection confidence scores. In some embodiments, the association process includes a hierarchical matching algorithm that prioritizes higher-confidence predictions and checks consistency with anatomical constraints (e.g., a face should be above the torso). The output of this process is a structured representation for each subject that includes a set of body portions known to belong together, enabling accurate tracking and behavior analysis in later stages.

The system generates 1360 a bounding box to annotate the human subject containing the associated set of body portions in the image. After associating the relevant body portions into unified subject representations, the system generates a bounding box for each subject to encapsulate the associated features within the image. These bounding boxes are not simple rectangular enclosures but are generated based on the distribution of associated semantic centers and the extents of posture keypoints. The system may also consider predicted visibility scores to exclude outlier points or compensate for occluded regions. The resulting bounding box serves as an annotation for downstream tasks, such as real-time monitoring, alert generation, or visual overlay in user interfaces. In some embodiments, the bounding boxes may be augmented with metadata such as detection confidence, subject ID, or estimated activity class. These annotations allow users or automated systems to process each human subject individually, track them over time, and integrate the data into higher-level analytics platforms or security workflow.

The disclosed systems, such as system 100 of FIG. 1, may be a system that performs computing and can be configured in various ways, including, without limitation, a cloud system/platform, a shared computing system, a server farm, a proprietary system, a networked Intranet system, a centralized system, or a distributed system, among others, or a combination of such systems. FIG. 1 shows a block diagram of exemplary components of a system or device according to the disclosed systems and devices. The block diagram is provided to illustrate possible implementations of various parts of the disclosed systems and devices.

The disclosed systems, such as system 100, may include a hardware processor or a controller that may be or include, for example, one or more central processing unit processor(s) (CPU), one or more Graphics Processing Unit(s) (GPU or GPGPU), and/or other types of processor, such as a microprocessor, digital signal processor, microcontroller, programmable logic device (PLD), field programmable gate array (FPGA), or any suitable computing or computational device. The disclosed systems, such as system 100, may also include an operating system, a memory (e.g., memory 120), a storage (e.g., storage device 150) and a communication device (e.g., communication device 140).

The communication device may include one or more transceivers which allow communications with remote or external devices (e.g., edge processing devices 190A-190C) and may implement communications standards and protocols, such as cellular communications (e.g. 3G, 4G, 5G, CDMA, GSM), Ethernet, Wi-Fi, Bluetooth, low energy Bluetooth, Zigbee, Internet-of-Things protocols (such as mosquito MQTT), and/or USB, among others.

The memory, such as memory 120, may be or may include, for example, one or more Random Access Memory (RAM), read-only memory (ROM), flash memory, volatile memory, non-volatile memory, cache memory, and/or other memory devices. The memory may store, for example, executable instructions that carry out an operation (e.g., executable code) and/or data. Executable code may be any executable code, e.g., an app/application, a program, a process, task, subtask or script, e.g., to execute the software-based multitask detector or model such as model 300 of FIG. 3. The executable code may be executed by a controller such as controller 110.

The storage, such as storage device 150, may be or may include, for example, one or more of a hard disk drive, a solid state drive, an optical disc drive (such as DVD or Blu-Ray), a USB drive or other removable storage device, and/or other types of storage devices. Data such as instructions, code, procedure data, and images, such as input image 305 of FIG. 3 or training images, among other things, may be stored in the storage and may be loaded from the storage into the memory (e.g., memory 120) where it may be processed by a controller (e.g., controller 110).

The illustrated components of FIG. 1 are exemplary and variations are contemplated to be within the scope of the present disclosure. For example, the numbers of components may be greater or fewer than as described and the types of components may be different than as described. When the system, such as system 100, implements a machine learning system, e.g., by running a machine-learning network or model, a large number of graphics processing units may be utilized, for example. When system 100 implements a data storage system, a large number of storages may be utilized. As another example, when system 100 implements a server system, a large number of central processing units or cores may be utilized. Other variations and applications are contemplated to be within the scope of the present disclosure.

The aspects described above are exemplary and variations are contemplated to be within the scope of the present disclosure.

Accordingly, systems, methods, and applications for multitask detection have been described herein. For purposes of explanation, specific configurations and details are set forth in order to provide a thorough understanding of aspects of the disclosed technology. However, it is apparent to one skilled in the art that the disclosed technology can be practiced without using every aspect presented herein.

Different aspects are disclosed herein. Features of certain aspects can be combined with features of other aspects; thus certain aspects can be combinations of features of multiple aspects.

While several embodiments of the disclosure have been described herein and/or shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

### ADDITIONAL CONSIDERATIONS

The embodiments described herein provide a technical improvement over conventional autoscaling systems by introducing a predictive, seasonality-aware approach to compute resource provisioning in containerized environments. Traditional reactive autoscalers adjust resource allocations only after utilization metrics exceed predefined thresholds, leading to delayed response, under-provisioning during usage spikes, and inefficient over-provisioning during idle periods. In contrast, the embodiments described herein apply frequency-domain analysis—such as Fast Fourier Transform (FFT)—to detect recurring patterns in historical workload usage data and generate forward-looking forecasts that anticipate future demand. These predictions are used to produce time-based scaling recommendations that proactively adjust vertical and/or horizontal autoscaling parameters before demand inflection points occur. By aligning resource allocations with the periodic structure of workload behavior, the system reduces response latency, minimizes scaling oscillations, and improves both performance stability and infrastructure efficiency. The integration of multiple prediction strategies-selected based on the strength and complexity of seasonality-further enhances adaptability across diverse workload profiles, resulting in a more intelligent and responsive autoscaling framework.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and is modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method for multitask detection, comprising:
receiving a captured image comprising one or more human subjects;
detecting, by a pre-trained multitask detection model, a plurality of body portions of the one or more human subjects, the plurality of body portions comprising at least a head, a body, and a plurality of posture body points;
determining, for each detected body portion among the plurality of body portions, a semantic center of the body portion;
determining a plurality of vectors between the semantic centers of the plurality of body portions;
for each human subject among the one or more human subjects, associating a set of detected body portions based on the plurality of vectors between the semantic centers of the set of detected body portions; and
generating a bounding box annotating the human subject containing the associated set of body portions in the image.

2. The method of claim 1, wherein determining the semantic center of each detected body portion comprises:
identifying at least one posture body point corresponding to a shoulder and at least one posture body point corresponding to a hip; and
determining the semantic center based on coordinates of the identified shoulder and hip points.

3. The method of claim 1, wherein the plurality of body posture points include body posture points corresponding to heads, shoulders, elbows, knees, ankles, hips, and wrists.

4. The method of claim 1, wherein determining the plurality of vectors comprises predicting, via a trained association module, a set of two-dimensional displacement vectors between the semantic centers of a face, a head, and a body.

5. The method of claim 1, wherein associating a set of detected body portions comprises applying a hierarchical matching process that evaluates detection confidence and geometric relationships.

6. The method of claim 1, further comprising generating visibility confidence scores for each of the plurality of posture body points, indicating a likelihood that a corresponding posture body point is visible.

7. The method of claim 6, wherein associating the set of detected body portions based on the plurality of vectors between the semantic centers of the set of detected body portions is further based on visibility confidence scores of the detected posture body points.

8. The method of claim 1, wherein determining the plurality of posture body points comprises a two-stage regression process comprising:
identifying intermediate body landmarks based on the semantic centers of the body portions;
extracting image patches centered around the intermediate body landmarks; and
determining positions of the plurality of posture body points based on the image patches centered around the intermediate body landmarks.

9. The method of claim 1, wherein the pre-trained multitask detection model is trained by:
training a plurality of teacher models using labeled training images, wherein each of the plurality of teacher models is trained to detect a respective body portion;
applying the plurality of teacher models to unlabeled images to detect respective body portions;
labeling the unlabeled images based on the detected body portions; and
training a student multitask detection model based on the labeled images generated by the plurality of teacher models.

10. The method of claim 9, wherein the plurality of teacher models includes a first teacher model trained to detect a head and a second teacher model trained to detect a body.

11. A non-transitory computer readable storage medium for storing instructions that when executed by one or more processors cause the one or more processors to perform steps comprising:
receiving a captured image comprising one or more human subjects;
detecting, by a pre-trained multitask detection model, a plurality of body portions of the one or more human subjects, the plurality of body portions comprising at least a head, a body, and a plurality of posture body points;
determining, for each detected body portion among the plurality of body portions, a semantic center of the body portion;
determining a plurality of vectors between the semantic centers of the plurality of body portions;
for each human subject among the one or more human subjects,
associating a set of detected body portions based on the plurality of vectors between the semantic centers of the set of detected body portions; and
generating a bounding box annotating the human subject containing the associated set of body portions in the image.

12. The non-transitory computer readable storage medium of claim 11, wherein determining the semantic center of each detected body portion comprises:
identifying at least one posture body point corresponding to a shoulder and at least one posture body point corresponding to a hip; and
determining the semantic center based on coordinates of the identified shoulder and hip points.

13. The non-transitory computer readable storage medium of claim 11, wherein the plurality of body posture points include body posture points corresponding to heads, shoulders, elbows, knees, ankles, hips, and wrists.

14. The non-transitory computer readable storage medium of claim 11, wherein determining the plurality of vectors comprises predicting, via a trained association module, a set of two-dimensional displacement vectors between the semantic centers of a face, a head, and a body.

15. The non-transitory computer readable storage medium of claim 11, wherein associating a set of detected body portions comprises applying a hierarchical matching process that evaluates detection confidence and geometric relationships.

16. The non-transitory computer readable storage medium of claim 11, the steps further comprising generating visibility confidence scores for each of the plurality of posture body points, indicating a likelihood that a corresponding posture body point is visible.

17. The non-transitory computer readable storage medium of claim 16, wherein associating the set of detected body portions based on the plurality of vectors between the semantic centers of the set of detected body portions is further based on visibility confidence scores of the detected posture body points.

18. The non-transitory computer readable storage medium of claim 11, wherein determining the plurality of posture body points comprises a two-stage regression process comprising:
identifying intermediate body landmarks based on the semantic centers of the body portions;
extracting image patches centered around the intermediate body landmarks; and
determining positions of the plurality of posture body points based on the image patches centered around the intermediate body landmarks.

19. The non-transitory computer readable storage medium of claim 11, wherein the pre-trained multitask detection model is trained by:
training a plurality of teacher models using labeled training images, wherein each of the plurality of teacher models is trained to detect a respective body portion;
applying the plurality of teacher models to unlabeled images to detect respective body portions;
labeling the unlabeled images based on the detected body portions; and
training a student multitask detection model based on the labeled images generated by the plurality of teacher models.

20. A computing system, comprising:
one or more processors; and
a non-transitory computer readable storage medium for storing instructions that when executed by the one or more processors cause the one or more processors to perform steps comprising:
receiving a captured image comprising one or more human subjects;
detecting, by a pre-trained multitask detection model, a plurality of body portions of the one or more human subjects, the plurality of body portions comprising at least a head, a body, and a plurality of posture body points;
determining, for each detected body portion among the plurality of body portions, a semantic center of the body portion;
determining a plurality of vectors between the semantic centers of the plurality of body portions;
for each human subject among the one or more human subjects,
associating a set of detected body portions based on the plurality of vectors between the semantic centers of the set of detected body portions; and
generating a bounding box annotating the human subject containing the associated set of body portions in the image.
